(19) United States
(12) Patent Application Publication
(10) Pub. No.: US 2021/0046953 A1
(43) Pub. Date: Feb. 18, 2021

(54) EFFICIENT INFERENCE UPDATE USING BELIEF SPACE PLANNING

(71) Applicant: TECHNION RESEARCH & DEVELOPMENT FOUNDATION LIMITED, Haifa (IL)

(72) Inventors: Vadim INDELMAN, Haifa (IL); Elad FARHI, Haifa (IL)

(21) Appl. No.: 16/978,731

(22) PCT Filed: Mar. 6, 2019
(86) PCT No.: PCT/IL2019/050249

§ 371 Date: Sep. 7, 2020

Related U.S. Application Data
(60) Provisional application No. 62/639,046, filed on Mar. 6, 2018.

(51) Int. Cl. B60W 60/00; G06N 5/04; B60W 50/00; B60W 30/095; G06N 7/00

(52) U.S. Cl. CPC B60W 60/00272; G06N 5/04; G06N 7/005; B60W 30/0953; B60W 50/0097

(57) ABSTRACT

An autonomous system comprising: at least one hardware processor; a sensors module; and a non-transitory computer-readable storage medium having stored thereon program instructions, the program instructions executable by the at least one hardware processor to: receive, from said sensors module, a set of measurements associated with a joint state of said autonomous system, infer, based, at least in part, on said set of measurements, a current belief regarding said joint state of said autonomous system, determine a control action based on said inference, wherein said determining comprises calculating a future belief regarding a future joint state of said autonomous system, wherein said future joint state is as a result of said control action, execute said control action, and generate a new inference based, at least in part, on said future belief, wherein said future belief is updated based on a new set of measurements from said sensors module.

### CROSS-REFERENCE TO RELATED APPLICATIONS

This application claims the benefit of U.S. Provisional Patent Application No. 62/639,046 filed Mar. 6, 2018, the contents of which is incorporated herein by reference in its entirety.

### BACKGROUND

The invention relates to the field of artificial intelligence.

Inference and decision making under uncertainty are key processes in every autonomous system and numerous robotic problems. In recent years, the similarities between inference and decision making triggered much work revolving around the duality between the two. In spite of these efforts, inference and control, as well as inference and belief space planning (BSP), are still mostly treated as two separate processes.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, an autonomous system comprising: at least one hardware processor; a sensors module; and a non-transitory computer-readable storage medium having stored thereon program instructions, the program instructions executable by the at least one hardware processor to: receive, from said sensors module, a set of measurements associated with a joint state of said autonomous system, infer, based, at least in part, on said set of measurements, a current belief regarding said joint state of said autonomous system, determine a control action based on said inference, wherein said determining comprises calculating a future belief regarding a future joint state of said autonomous system, wherein said future joint state is as a result of said control action, execute said control action, and generate a new inference based, at least in part, on said future belief, wherein said future belief is updated based on a new set of measurements from said sensors module.

There is also provided, in an embodiment, a method comprising using at least one hardware processor for: receiving, from a sensors module, a set of measurements associated with a joint state of an autonomous system, inferring, based, at least in part, on said set of measurements, a current belief regarding said joint state of said autonomous system, determining a control action based on said inference, wherein said determining comprises calculating a future belief regarding a future joint state of said autonomous system, wherein said future joint state is as a result of said control action, executing said control action, and generating a new inference based, at least in part, on said future belief, wherein said future belief is updated based on a new set of measurements from said sensors module.

There is further provided, in an embodiment, a computer program product comprising a non-transitory computer-readable storage medium having program instructions embodied therewith, the program instructions executable by at least one hardware processor to: receive, from a sensors module, a set of measurements associated with a joint state of an autonomous system, infer, based, at least in part, on said set of measurements, a current belief regarding said joint state of said autonomous system, determine a control action based on said inference, wherein said determining comprises calculating a future belief regarding a future joint state of said autonomous system, wherein said future joint state is as a result of said control action, execute said control action, and generate a new inference based, at least in part, on said future belief, wherein said future belief is updated based on a new set of measurements from said sensors module.

In some embodiments, said control action implements a specified task of said autonomous vehicle.

In some embodiments, said joint state of said autonomous system comprises at least some of (i) a current pose of said autonomous system, (ii) past poses of said autonomous system, and (iii) observed landmarks in an environment of said autonomous system.

In some embodiments, said current belief represents a probability of said joint state.

In some embodiments, said control action changes said joint state of said autonomous system.

In some embodiments, said determining comprises determining a sequence of control actions.

In some embodiments, said future belief is calculated based on at least some of (i) simulating an application of said first control action to said current belief, and (ii) predicting a future set of said measurements.

In some embodiments, said updating of said future belief comprises correcting data associations of at least one variable and one measurement between (i) said future belief, and (ii) said new set of said measurements from said sensors module, when said data associations are inconsistent.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1A illustrates existing plan-act-infer frameworks of a typical autonomous system;

FIG. 1B illustrates a high level flowchart of the present approach, according to an embodiment;

FIGS. 2A-2E illustrate a proposed approach of data association update, according to an embodiment;

FIGS. 3A-3B illustrate experimental average timing results for the present approach, according to an embodiment;

FIGS. 4A-4C present the experimental performance results of several methods of the present approach, according to an embodiment;

FIGS. 5A-5B present an experimental simulation of the present approach, according to an embodiment;

FIGS. 6A-6B illustrate the per-step analysis of the experimental simulation presented in FIGS. 5A-5B, according to an embodiment;

FIGS. 7A-7B present KITTI experiment layout and results, according to an embodiment;

FIGS. 8A-8B illustrate KITTI experiment relative estimation error between iSAM and UD-OTM-OO, according to an embodiment; and

FIGS. 9A-9B illustrate KITTI experiment per-step analysis of computation time, according to an embodiment.

### DETAILED DESCRIPTION

Disclosed herein are a method, system, and computer program product for efficient inference update using belief space planning (BSP).

In some embodiments, the present disclosure may be implemented in a variety of practical autonomous systems and/or robotics tasks, for example, in the context of autonomous navigation, guiding aerial vehicles in turbulent conditions, maneuvering mobile robots in unfamiliar terrain, and robotically steering flexible medical needles to clinical targets in soft tissues.

Practical scenarios in autonomous systems and artificial intelligence involve agents that are expected to reliably and efficiently operate under different sources of uncertainty, often with limited knowledge regarding the environment. Some examples are autonomous navigation and simultaneous localization and mapping (SLAM), search and rescue scenarios, object manipulation and robot-assisted surgery. These settings necessitate probabilistic reasoning regarding high dimensional problem-specific states. For instance, in SLAM, the state typically represents robot poses and mapped static or dynamic landmarks, while in environmental monitoring and other sensor deployment-related problems, the state corresponds to an environmental field to be monitored (e.g., temperature as a function of position and/or time).

Attaining these levels of autonomy involves two key processes:
Inference, which is the process of maintaining a belief regarding the high-dimensional state of an autonomous vehicle in relation to its environment, given available information.
Decision making under uncertainty (often referred to as belief space planning—BSP), which is the process of determining the next optimal action or set of actions for the autonomous vehicle.

The inference problem has been addressed by the research community extensively over the past decades. In particular, focus was given to inference over high-dimensional state spaces, with SLAM being a representative problem, and to computational efficiency to facilitate online operation, as required in numerous robotics systems.

Over the years, the solution paradigm for the inference problem has evolved. From EKF-based methods, through information form recursive and smoothing methods, and in recent years up to incremental smoothing approaches, such as iSAM and iSAM2.

Given the posterior belief from the inference stage, decision making under uncertainty and belief space planning approaches are entrusted with providing the next optimal action sequence given a certain objective. The aforementioned is accomplished by reasoning about belief evolution for different candidate actions while taking into account different sources of uncertainty. The corresponding problem is an instantiation of a partially observable Markov decision process (POMDP) problem, which is known to be computationally intractable for all but the smallest problems, i.e. no more than few dozen states.

A crucial component in both inference and BSP is data association (DA), i.e., associating between sensor observations and the corresponding landmarks. Incorrect DA in inference or BSP can lead to catastrophic failures, due to wrong estimation in inference or incorrect belief propagation within BSP that would result in incorrect, and potentially unsafe, actions.

Regardless of the decision making approach being used, in order to determine the next action or actions, the current belief is propagated using various action sequences. The propagated beliefs are then solved in order to provide an objective function value, thus enabling the determination of the next actions. Solving a propagated belief is equivalent to preforming inference over the belief, hence solving multiple inference problems is inevitable when trying to determine the next actions.

However, despite the similarities between inference and decision making, the two problems have been typically treated separately, thus duplicating costly calculations and increasing valuable computation time.

Accordingly, in some embodiments, the present disclosure is based, at least in part, on the observation that similarities between inference and decision making paradigms could be utilized in order to reduce computational complexity within the context of control of autonomous systems.

In contrast to the notion of joint inference and control, which considers a Markov Decision Process (MDP) setting, in some embodiments, the present disclosure considers a partially observable Markov Decision Process (POMDP) setting. Through the symbiotic relation enabled by considering the joint inference and BSP problems, it may be observed that inference can be efficiently updated using a preliminary planning stage.

Updating inference with a preliminary planning stage can be considered as a departure from conventional Bayesian inference. Rather than updating the belief from the previous time instant with new incoming information (e.g., new sensor measurements), it is proposed to exploit the fact that similar calculations have already been performed within planning, in order to appropriately update the belief in inference more efficiently.

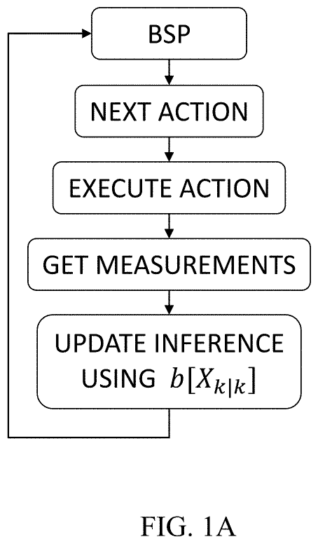

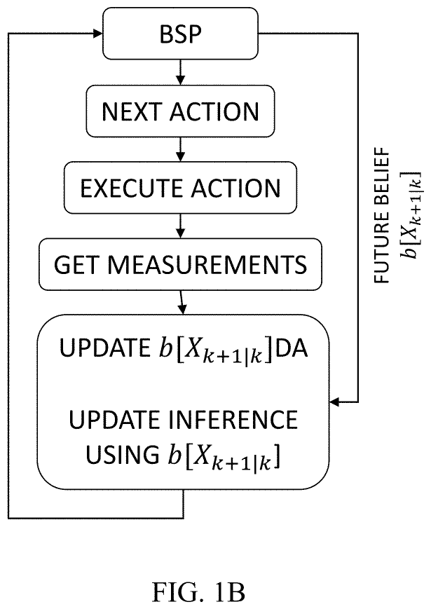

FIG. 1A illustrates the standard plan-act-infer framework of a typical autonomous system with conventional Bayesian approach for inference update. First, BSP determines the next best action given the posterior belief at current time; the action is executed; information is gathered and the former belief from the preliminary inference is updated with new information (e.g., sensor measurements); the new posterior belief is then transferred back to the planning block in order to propagate it into future beliefs and provide again with the next action.

FIG. 1B illustrates the present approach, which differs from the conventional Bayesian inference in two aspects: The output of the BSP process, and the procedure of inference update.

In the present approach, BSP output includes the next action as well as the corresponding propagated future beliefs. These beliefs are used to update inference while potentially taking care of data association (DA) aspects, rather than using only the belief from preliminary inference as conventionally done under Bayesian inference.

As can be seen in FIG. 1B, the inference block contains data association (DA) update before the actual inference update, because there are multiple elements that can cause the DA in planning to be partially different than the DA established in the successive inference, e.g., estimation errors, disturbances, and dynamic or un-modeled unseen environments.

In some embodiments, the present disclosure is based, at least in part, on a simplifying assumption that the DA considered in planning is consistent with that acquired during the succeeding inference, e.g., an association is predicted to a specific known or previously mapped landmark. Because data association only relates to connections between variables and not to the measurement value, the (potentially) incorrect measurement values, used within planning, may need to be replaced with the actual values. Under this assumption, in some embodiments, there are provided methods to efficiently update inference using the belief calculated by the preliminary planning phase. As will be seen, these methods provide the same or similar estimation accuracy as the conventional Bayesian inference approach, however, with a significantly shorter computation time.

In some embodiments, the present disclosure considers the joint inference and belief space planning problem in a model predictive control (MPC) setting, i.e., BSP is performed after each inference phase. This problem can be roughly divided into two successive and recursive stages, namely inference and planning. The former performs inference given all information up to current time, updating the belief over the state with incoming information (e.g. sensor measurements). The latter produces the next control action, given the belief from the former inference stage and a user defined objective function.

A potential advantage of the present disclosure, is therefore, in that it provides for a novel approach for saving computational resources during the inference stage, by reusing calculations made during the preliminary planning stage. The present disclosure thus recovers valuable computational time in the inference update stage, by exploiting the similarities between inference and preliminary planning, without affecting solution accuracy or introducing new assumptions.

In some embodiments, the present disclosure assumes consistent DA. In some embodiments, the present disclosure further provides for incrementally updating inconsistent DA.

### Problem Formulation

Let xₜ denote an autonomous system's state at time t, and [symbol] represent the world state if the latter is uncertain or unknown. For example, for SLAM problem, it could represent objects or 3D landmarks. The joint state, up to time k, is defined as Xₖ={x₀, . . . xₖ, [symbol] }∈Rⁿ. The notation t|k will be used to refer to time t while considering information up to time k, which will allow referring to sequential inference and planning phases in a unified manner.

Let z_{t|k} and u_{t|k} denote, respectively, the obtained measurements and the applied control action at time t, while the current time is k. For example, z_{(k+1|k)} represents measurements from a future time k+1 while z_{(k-1|k)} represents measurements from a past time k−1, with the present time being k in both cases.

Representing the measurements and controls up to time t, given current time k, as

z_{1:t|k}≐{z_{1|k}, . . . , z_{t|k}},u_{0:t-1|k}≐{u_{0|k}, . . . , u_{t-1|k}}, (1)

the posterior probability density function (pdf) over the joint state, denoted as the belief, is given by

b[X_{t|k}]≐ [symbol] (Xₜ|z_{1:t|k},u_{0:t-1k}). (2)

For t=k, Eq. (2) represents the posterior at current time k, while for t>k it represents planning stage posterior for a specific sequence of future actions and observations. Using Bayes rule, Eq. (2) can be rewritten as

[symbol]

(Xₜ|z_{1:t|k},u_{0:t|k})∝ [symbol] (x₀)·Πᵢ₌₁^{t}[ [symbol] (xᵢ|xᵢ₋₁,u_{i-1|k}) [symbol] [symbol] (z_{i|k}^{j}|xᵢ,lⱼ)] (3)

where [symbol] (X₀) is the prior on the initial joint state, [symbol] (xᵢ|xᵢ₋₁,uᵢ₋₁|ₖ) and [symbol] (z_{i|k}^{j}|xᵢ,lⱼ) denote, respectively, the motion and measurement likelihood models. The set [symbol] _{i|k} contains all landmark indices observed at time i, i.e., it denotes data association (DA). The measurement of some landmark j at time i is denoted by z_{i|k}^{j}∈z_{i|k}.

Under graphical representation of the belief, the conditional probabilities of the motion and observation models as well as the prior, can be denoted as factors. Eq. (3) can also be represented by a multiplication of these factors

[symbol]

(Xₜ|z_{1:t|k},u_{0:t-1|k})∝Πᵢ₌₀^{t}{ƒⱼ}_{i|k} (4)

where {ƒⱼ}_{i|k} represents all factors added at time i while current time is k. The motion and measurement models are conventionally modeled with additive zero-mean Gaussian noise, while this formulation is also valid for some general distribution.

xᵢ₊₁=ƒ(xᵢ,uᵢ)+wᵢ,wᵢ˜ [symbol] (0,Σ_{w}) (5)

zᵢ^{j}=h(xᵢ,uᵢ)+wᵢ,wᵢ˜ [symbol] (0,Σ_{w}) (5)

where ƒ and h are known possibly non-linear functions, Σ_{w} and Σᵥ are the process and measurement noise covariance matrices, respectively.

For the inference problem, t≤k, i.e., time instances that are equal or smaller than current time. The maximum a posteriori (MAP) estimate of the joint state Xₖ is given by

$${X}_{k \vert k}^{★} = {arg max}_{{X}_{k}} b [ {X}_{k \vert k} ] = {arg max}_{{X}_{k}} ℙ ( {X}_{k} \vert {z}_{1 \text{:} k \vert k} , {u}_{0 \text{:} k - 1 \vert k} ) . \qquad ( 7 )$$

The MAP estimate from Eq. (7) is referred to as the inference solution, in which, all controls and observations until time instant k are known.

As mentioned, the purpose of planning is to determine the next optimal action(s). Finite horizon belief space planning for L look ahead steps involves inference over the beliefs

b[X_{k+l|k}]= [symbol] (Xₖ₊ₗ|z_{1:k+l|k},u_{0:k+l-1|k}),l∈[k+1,k+L] (8)

where the same notation is used as in Eq. (2) to denote the current time is k. The belief (8) can be written recursively as a function of the belief b[X_{k|k}] from the inference phase as

b[X_{k+l|k}]=b[X_{k|k}]·Πᵢ₌ₖ₊₁^{k+l}[ [symbol] (xᵢ|xᵢ₋₁,u_{i-|k}) [symbol] [symbol] (z_{i|k}^{j},xᵢ,lⱼ)], (9)

for the considered action sequence u_{k:k+l-1|k} at planning time k, and observations z_{k+1:k+l|k} that are expected to be obtained upon execution of these actions. The set [symbol] denotes landmark indices that are expected to be observed at a future time instant i.

It is now possible to define a general objective function:

$$J ( {u}_{k - 1 \text{:} k + L - 1 \vert k} ) \dot{=} {𝔼}_{{z}_{k + 1 \text{:} k + L \vert k}} [ {\sum }_{i = k + 1}^{k + L} {c}_{i} ( b [ {X}_{i \vert k} ] , {u}_{i - 1 \vert k} ) ] , \qquad ( 10 )$$

with immediate costs (or rewards) cᵢ and where the expectation considers all the possible realizations of the future observations z_{k+1:k+L|k}. Conceptually, one could also reason whether these observations will actually be obtained, e.g., by considering also different realizations of [symbol] . Note that for information-theoretic costs (e.g., entropy) and Gaussian distributions considered herein, it can be shown that the expectation operator can be omitted under maximum-likelihood observations assumption, while another alternative is to simulate future observations via sampling, if such a simulator is available.

The optimal control can now be defined as

$${u}_{k \text{:} k + L - 1 \vert k}^{★} = {arg min}_{{u}_{k \text{:} k + L - 1 \vert k}} J ( {u}_{k \text{:} k + L - 1 \vert k} ) . \qquad ( 11 )$$

Evaluating the objective function (10) for a candidate action sequence involves calculating belief evolution for the latter, i.e. solving the inference problem for each candidate action using predicted future associations and measurements.

### Inference Update Using BSP

As demonstrated above, inference and BSP share similar calculations. This observation is impervious to any specific paradigms used for inference or planning.

In other words, unlike the conventional paradigm in which inference over b[X_{k+1|k+1}] is obtained by updating b[X_{k|k}] with newly acquired information (actions, measurements), the present disclosure provides for performing inference more efficiently by exploiting b[X_{k+1|k}], which has already been calculated as part of the planning phase at time k.

Calculating the next optimal action u_{k|k}*∈u_{k:k+L-1|k}* within BSP necessarily involves inference over the belief b[X_{k+1|k}] Conditioned on the same action u_{k|k}*. This belief b[X_{k+1|k}] can be different than b[X_{k+1|k+1}] (the posterior at current time k+1) due to partially inconsistent data association and difference between measurement values considered in planning and those obtained in practice in inference. The present approach takes care of both of these aspects, thereby enabling to obtain b[X_{k+1|k+1}] from b[X_{k+1|k}].

In the following, the similarities between inference and BSP are first analyzed, and the insights used to develop methods for inference update under a simplifying assumption of consistent DA. The DA assumption is then relaxed by analyzing the possible scenarios for inconsistent DA between inference and precursory planning, and deriving a method for updating inconsistent DA.

It is worth stressing that the only thing needed to be changed in any BSP algorithm in order to support the present disclosure is only adding more information to its output. More specifically, outputting not only the (sub)optimal action u_{k|k}*, but also the corresponding future belief b[X_{k+1|k}].

To better understand the similarities between inference and precursory planning, let us break down the inference solution to its components. Introducing Eqs. (3-6) into Eq. (7) and taking the negative logarithm yields the following non-linear least squares problem (NLS)

$${X}_{k \vert k}^{★} = {arg min}_{{X}_{k}} {‖ {x}_{0} - {x}_{0}^{★} ‖}_{{Σ}_{0}}^{2} + {\sum }_{i = 1}^{k} \\ [ {‖ {x}_{i} - f ( {x}_{i - 1} , {u}_{i - 1 \vert k} ) ‖}_{{Σ}_{w}}^{2} + {Σ}_{j ∈ {ℳ}_{i} \vert k} {‖ {z}_{i \vert k}^{j} - h ( {x}_{i} , {l}_{j} ) ‖}_{{Σ}_{v}}^{2} ] , \qquad ( 12 )$$

where ∥a∥_{Σ}²≐=a^{T}Σ⁻¹a is the squared Mahalanobis norm.

Linearizing each of the terms in Eq. (12) and performing standard algebraic manipulations yields

$$Δ {X}_{k \vert k}^{★} = {arg min}_{Δ {X}_{k}} {‖ {A}_{k \vert k} Δ {X}_{k} - {b}_{k \vert k} ‖}^{2} , \qquad ( 13 )$$

where A_{k|k}∈ [symbol] ^{m×n} is the Jacobian matrix and b_{k|k} ∈ [symbol] ^{m} is the right hand side (RHS) vector. In a more elaborated representation

$${A}_{k \vert k} = [ \begin{matrix}{Σ}_{0}^{- \frac{1}{2}} \\ {ℱ}_{1 \text{:} k \vert k} \\ {ℋ}_{1 \text{:} k \vert k}\end{matrix} ] , {b}_{k \vert k} = [ \begin{matrix}0 \\ {\breve{b}}_{1 \text{:} k \vert k}^{ℱ} \\ {\breve{b}}_{1 \text{:} k \vert k}^{ℋ}\end{matrix} ] , \qquad ( 14 )$$

wherein [symbol] _{1:k|k}, [symbol] _{1:k|k}, [symbol] and [symbol] denote the Jacobian matrices and RHS vectors of all motion and observation terms accordingly, for time instances 1:k when the current time is k. These Jacobians, along with the corresponding RHS can be referred to by

$${𝒜}_{1 \text{:} k \vert k} = [ \begin{matrix}{ℱ}_{1 \text{:} k \vert k} \\ {ℋ}_{1 \text{:} k \vert k}\end{matrix} ] , {\breve{b}}_{1 \text{:} k \vert k} = [ \begin{matrix}{\breve{b}}_{1 \text{:} k \vert k}^{ℱ} \\ {\breve{b}}_{1 \text{:} k \vert k}^{ℋ}\end{matrix} ] , \qquad ( 15 )$$

While there are a few methods to solve Eq. (2), QR factorization was chosen. The QR factorization of the Jacobian matrix A_{k|k} is given by the orthonormal rotation matrix Q_{k|k} and the upper triangular matrix R_{k|k}

A_{k|k}=Q_{k|k}R_{k|k}. (16)

Eq. (16) is introduced into Eq. (13), thus producing

R_{k|k}ΔXₖ=d_{k|k}, (17)

where R_{k|k} is un upper triangular matrix and d_{k|k} is the corresponding RHS vector, given by the original RHS vector and the orthonormal rotation matrix Q_{k|k}

d_{k|k}≐Q_{k|k}^{T}b_{k|k}. (18)

It is now possible to solve Eq. (17) for ΔXₖ via back substitution, update the linearization point, and repeat the process until convergence. Eq. (17) can also be presented using a Bayes tree (BT). A BT is a graphical representation of a factorized Jacobian matrix (the square root information matrix) R and the corresponding RHS vector d, in the form of a directed tree. One can substantially reduce running time by exploiting sparsity and updating the QR factorization from the previous step with new information instead of calculating a factorization from scratch, see e.g. iSAM2 algorithm.

To summarize, the belief b[X_{k|k}] can be represented as the Gaussian

b[X_{k|k}]≐ [symbol] (Xₖ|z_{1:k|k},u_{0:k-1|k})= [symbol] (X_{k|k}*,Λ_{k|k}⁻¹), (19)

while the information matrix is given by

Λ_{k|k}=A_{k|k}^{T}A_{k|k}=R_{k|k}^{T}R_{k|k}, (20)

and the factorized Jacobian matrix R_{k|k} along with the corresponding RHS vector d_{k|k} can be used to update the linearization point and to recover the MAP estimate. In other words, the factorized Jacobian matrix R_{k|k} and the corresponding RHS vector d_{k|k} are sufficient for performing a single iteration within Gaussian belief inference.

An interesting insight is that the underlying equations of BSP are similar to those seen above and, in particular, evaluating the belief at the Lth look ahead step, b[X_{k+L|k}], involves MAP inference over a certain action sequence u_{k:k+l-1|k} and future measurements z_{k+1:k+l|k}, which in turn can be described as an NLS problem

$${X}_{k + L \vert k}^{★} = {arg min}_{{X}_{k + L}} {‖ {X}_{k} - {X}_{k \vert k}^{★} ‖}_{{Λ}_{k \vert k}^{- 1}}^{2} + {\sum }_{i = k + 1}^{k + L} \\ [ {‖ {x}_{i} - f ( {x}_{i - 1} , {u}_{i - 1 \vert k} ) ‖}_{{Σ}_{w}}^{2} + {Σ}_{j ∈ {ℳ}_{i} \vert k} {‖ {z}_{i \vert k}^{j} - h ( {x}_{i} , {l}_{j} ) ‖}_{{Σ}_{v}}^{2} ] \qquad ( 21 )$$

For i>k, the set [symbol] _{i|k} contains predicted associations for future time instant i; hence, it can be written as

∀i>k,⋄( [symbol] _{i|k}≠ [symbol] _{i|i}), (22)

where ⋄ is an operator taken from Modal-Logic which stands for “Possibly”. In other words, it is possible that associations from the planning stage, [symbol] _{k+1|k}, would be partially different than the associations from the corresponding inference stage [symbol] _{k+1|k+1}. Moreover, the likelihood for inconsistent DA between planning and the corresponding inference rises as we look further into the future, i.e., with the distance ∥i−k∥ increasing; e.g., [symbol] _{k+j|k} and [symbol] _{k+j|k+j} are less likely to be identical for j=10 than they are for j=1.

Predicting the unknown measurements z_{k+1:k+L|k} in terms of both association and values can be done in various ways. For example, DA can be predicted using current state estimation, and measurement values are obtained using the maximum-likelihood (ML) assumption, i.e., assuming zero innovation. The system pose is first propagated using the motion model. All landmark estimations are then transformed to the system's new camera frame. Once in the system camera frame, all landmarks that are within the system's field of view are considered to be seen by the system (predicted DA). The estimated position of each landmark, that is considered as visible by the system, is being projected to the camera image plane, thus generating measurements. It is worth mentioning that the aforementioned methodology is not able to predict occurrences of new landmarks, since it is based solely on the map the system built thus far, i.e. current joint state estimation. The ability to predict occurrences of new landmarks would increase the advantage of the present disclosure inference over conventional Bayesian inference.

Once the predicted measurements are acquired, by following a similar procedure to the one presented above, for each action sequence we get

$$Δ {X}_{k + L \vert k}^{★} = {arg min}_{Δ {X}_{k + L}} {‖ {A}_{k + L \vert k} Δ {X}_{k + L} - {b}_{k + L \vert k} ‖}^{2} . \qquad ( 23 )$$

The Jacobian matrix A_{k+L|k} and RHS vector b_{k+L|k} are defined as

$${A}_{k + L \vert k} \dot{=} [ \begin{matrix}{A}_{k \vert k} \\ {𝒜}_{k + 1 \text{:} k + L \vert k}\end{matrix} ] , {b}_{k + L \vert k} \dot{=} [ \begin{matrix}{b}_{k \vert k} \\ {\breve{b}}_{k + 1 \text{:} k + L \vert k}\end{matrix} ] , \qquad ( 24 )$$

where A_{k|k} and b_{k|k} are taken from inference, see Eq. (13), and [symbol] _{j+1:k+L|k} and \check{b}_{k+1:k+L|k} correspond to the new terms obtained at the first L look ahead steps (e.g., see Eq. (15)). Note that although [symbol] _{k+1:k+L|k} is not a function of the (unknown) measurements z_{k+1:k+L|k}, it is a function of the predicted DA, [symbol] _{k+1:k+L|k}. Performing QR factorization, yields

A_{k+L|k}=Q_{k+L|k}R_{k+L|k}, (25)

from which the information matrix, required in the information-theoretic cost, can be calculated. Using Eq. (24) the belief that correlates to the specific action sequence can be estimated, enabling evaluating the objective function. Determining the best action via Eq. (11) involves repeating this process for different candidate actions.

In an MPC setting, only the first action from the sequence u_{k:k+L-1|k}* is executed, i.e.

u_{k|k+1}=u_{k|k}*∈u_{k:k+L-1|k}. (26)

In such case the difference between the belief obtained from BSP (for action u_{k|k}*)

b[X_{k+1|k}]≡ [symbol] (Xₖ₊₁−z_{1:k|k},u_{0:k-1|k},z_{k+1|k},u_{k|k}*), (27)

and the belief from the succeeding inference

b[X_{k+1|k+1}]≡ [symbol] (Xₖ₊₁|z_{1:k|k},u_{0:k-1|k},z_{k+1|k+1},u_{k|k+1}), (28)

is rooted in the set of measurements (i.e., z_{k+1|k+1} vs. z_{k+1|k}), and the corresponding factors added at time instant k+1. These factor sets, denoted by {ƒᵢ}_{k+1|k} and {ƒⱼ}_{k+1|k+1} accordingly, can differ from one another in data association and measurement values. Since solving the belief requires linearization, it is important to note that both beliefs, b[X_{k+1|k}] and b[X_{k+1|k+1}], make use of the same initial linearization point X̅ₖ₊₁ for the common variables1. Accordingly, it follows that

$${X}_{k + 1 \vert k} = [ \begin{matrix}{X}_{k \vert k} \\ {x}_{k + 1}\end{matrix} ] , {X}_{k + 1 \vert k + 1} = [ \begin{matrix}{X}_{k \vert k} \\ {x}_{k + 1} \\ {L}_{k + 1}^{new}\end{matrix} ] \qquad ( 29 )$$

where Lₖ₊₁^{new} represents the new landmarks that were added to the belief for the first time at time instant k+1. The linearization point for the common variables is [X_{k|k}, ƒ(xₖ, u_{k|k}*)] for planning, and [X_{k|k}*, ƒ(xₖ,u_{k|k+1})] for succeeding inference, where ƒ(.) is the motion model. Since the (sub)optimal action provided by BSP is the one executed in the succeeding inference, i.e., Eq. (26), the motion models are identical hence the same linearization point is used in both inference and precursory planning.

When considering the belief from planning Eq. (27), which is propagated with the next action Eq. (26) and predicted measurements, with the previously factorized form of A_{k|k} and b_{k|k}, we get

$${A}_{k + 1 \vert k} \dot{=} [ \begin{matrix}{R}_{k \vert k} \\ {𝒜}_{k + 1 \vert k}\end{matrix} ] , {b}_{k + 1 \vert k} \dot{=} [ \begin{matrix}{d}_{k \vert k} \\ {\breve{b}}_{k + 1 \vert k}\end{matrix} ] . \qquad ( 30 )$$

Similarly, when considering the a posteriori belief from inference Eq. (28), propagated with the next action Eq. (26) and acquired measurements, with the previously factorized form of A_{k|k} and b_{k|k}, we get

$${A}_{k + 1 \vert k 1} \dot{=} [ \begin{matrix}{R}_{k \vert k} \\ {𝒜}_{k + 1 \vert k + 1}\end{matrix} ] , {b}_{k + 1 \vert k 1} \dot{=} [ \begin{matrix}{d}_{k \vert k} \\ {\breve{b}}_{k + 1 \vert k + 1}\end{matrix} ] . \qquad ( 31 )$$

For the same action Eq. (26), the difference between Eq. (30) to the equivalent representation of standard Bayesian inference Eq. (31) originates from the factors added at time k+1

[symbol]

_{k+1|k} [symbol] [symbol] _{k+1|k+1}, (32)

b̆_{k+1|k} [symbol] b̆_{k+1|k+1}. (33)

Since the aforementioned share the same action sequence, the same linearization point and the same models, the differences remain limited to the DA and measurement values at time k+1.

In planning, DA is based on predicting which landmarks would be observed. This DA could very possibly be different than the actual landmarks the system observes, as expressed by Eq. (22). This inconsistency in DA manifests in both the Jacobian matrices and the RHS vectors. Even in case of consistent DA, the predicted measurements (if exist) would still be different than the actual measurements due to various reasons, e.g. the predicted position is different than the ground truth of the system, measurement noise, inaccurate models.

While for consistent DA and the same linearization point Eq. (32) will always be true, the RHS vectors, specifically Eq. (33), would still be different due to the difference in measurement values considered in planning and actually obtained in inference.

It is worth stressing that consistent data association between inference and precursory planning suggests that all predictions for state variable (new or existing) associations were in fact true. In addition to the new system state added each time instant, new variables could also manifest in the form of landmarks. Consistent DA implies that the future appearance of all new landmarks has been perfectly predicted during planning. Since a simple prediction mechanism is used which is unable to predict new landmarks, consistent DA would inevitably mean no new landmarks in inference, i.e, Lₖ₊₁^{new} is an empty set.

In the next section, the present disclosure is detailed using a relaxes DA assumption, by dealing with possible DA inconsistency prior to the update of the RHS vector, thus addressing the general and complete problem of inference update using the present disclosure.

Inference Update from BSP Assuming Consistent Data Association

Let us assume that the DA between inference and precursory planning is consistent, whether the cause is a “lucky guess” during planning or whether the DA inconsistency has been resolved beforehand. Recalling the definition of [symbol] _{i|k} (see, e.g., Eq. (12)), this assumption is equivalent to writing

[symbol]

_{k+1|k}≡ [symbol] _{k+1|k+1}. (34)

In other words, landmarks considered to be observed at a future time k+1, will indeed be observed at that time. Note this does not necessarily imply that actual measurements and system poses will be as considered within the planning stage, but it does necessarily state that both are considering the same variables and the same associations.

It is now observed that the motion models in both b[X_{k+1|k+1}] and b[X_{k+1|k}] are evaluated considering the same control (i.e., the optimal control uₖ*). Moreover, the system pose xₖ₊₁ is initialized to the same value in both cases as ƒ(xₖ, uₖ*), and thus the linearization point of all probabilistic terms in inference and planning is identical. This, together with the aforementioned assumption (i.e., Eq. (34) holds) allows writing A_{k+1|k}=A_{k+1|k+1}, and hence

R_{k+1|k+1}≡R_{k+1|k}, (35)

for the first iteration in the inference stage at time k+1.

Hence, in order to solve b[X_{k+1|k+1}], it is left to find the RHS vector d_{k+1|k+1}, while R_{k+1|k+1} can be entirely re-used.

Following are presented four methods that can be used for updating the RHS vector, and computational aspects of each are examined. It is worth noting that each of these methods results in an algebraically equivalent solution to standard inference update, hence provide with the same estimation accuracy.

### The Orthogonal Transformation Matrix Method—OTM

In the OTM method, obtain d_{k+1|k+1} is obtained following the definition as written in Eq. (18). Recall that at time k+1 in the inference stage, the posterior should be updated with new terms that correspond, for example, to motion model and obtained measurements. The RHS vector's augmentation, that corresponds to these new terms is denoted by b̆_{k+1|k+1}, see Eq. (15). Given R_{k|k} and d_{k|k} from the inference stage at time k, the augmented system at time k+1 is

$${A}_{k + 1 \vert k + 1} Δ {X}_{k + 1} \dot{=} [ \begin{matrix}{R}_{k \vert k} \\ {𝒜}_{k + 1 \vert k + 1}\end{matrix} ] Δ {X}_{k + 1} = [ \begin{matrix}{d}_{k \vert k} \\ {\breve{b}}_{k + 1 \vert k + 1}\end{matrix} ]$$

which after factorization of A_{k+1|k+1} (see Eqs. (16)-(18)) becomes

$$\begin{matrix}{R}_{k + 1 \vert k + 1} Δ {X}_{k + 1} = {d}_{k + 1 \vert k + 1} , \\ where & ( 36 ) \\ {d}_{k + 1 \vert k + 1} = {Q}_{k + 1 \vert k}^{T} [ \begin{matrix}{d}_{k \vert k} \\ {\breve{b}}_{k + 1 \vert k + 1}\end{matrix} ] . & ( 37 )\end{matrix}$$

As deduced from Eq. (37), the calculation of d_{k+1|k+1} requires Q_{k+1|k+1}. Since A_{k+1|k}≡A_{k+1|k+1}, we get Q_{k+1|k+1}=Q_{k+1|k}. However, Q_{k+1|k}, is already available from the precursory planning stage, see Eq. (25), and thus calculating d_{k+1|k+1} via Eq. (37) does not involve QR factorization in practice.

### The Downdate Update Method—DU

In the DU method it is proposed to re-use the d_{k+1|k} vector from the planning stage to calculate d_{k+1|k+1}.

Although not necessarily required within the planning stage, d_{k+1|k} could be calculated at that stage from b_{k+1|k} and Q_{k+1|k}, see Eqs. (24)-(25). However, b_{k+1|k} (unlike A_{k+1|k}) is a function of the unknown future observations z_{k+1|k}, which would seem to complicate things. The solution to this issue is as follows: A value for the observations z_{k+1|k} is assumed, and then d_{k+1|k} is calculated within the planning stage. As in inference at time k+1, the actual measurements z_{k+1|k+1} will be different, the contribution of z_{k+1|k} to d_{k+1|k} is removed via information downdating, and then appropriately incorporate z_{k+1|k+1} to get d_{k+1|k+1}.

More specifically, downdating the measurements z_{k+1|k} from d_{k+1|k} is done via

d_{k+1|k}^{aug}(R_{k+1|k}^{aug}^{^{−T}}(R_{k+1|k}^{T}d_{k+1|k}− [symbol] _{k+1|k}^{T}b̆_{k+1|k}), (38)

where b̆_{k+1|k} is a function of z_{k+1|k}, see Eqs. (21)-(24), and where R_{k+1|k}^{aug} is the downdated R_{k+1|k} matrix which is given by

R_{k+1|k}^{aug}^{^{T}}R_{k+1|k}^{aug}=A_{k+1|k}^{T}A_{k+1|k}− [symbol] _{k+1|k}^{T} [symbol] _{k+1|k}. (39)

Interestingly, the above calculations are not really required: Since d_{k|k} is already given from the previous inference stage, we can attain the downdated d_{k+1|k}^{aug} vector more efficiently by augmenting d_{k|k} with zero padding.

$${d}_{k + 1 \vert k}^{aug} = [ \begin{matrix}{d}_{k \vert k} \\ 0 \end{matrix} ] \qquad ( 40 )$$

While d_{k+1|k}^{aug} is the downdated RHS vector and 0 is a zero padding to match dimensions. Similarly, R_{k+1|k}^{aug} can be calculated as

$${R}_{k + 1 \vert k}^{aug} = [ \begin{matrix}{R}_{k \vert k} & 0 \\ 0 & 0\end{matrix} ] , \qquad ( 41 )$$

where R_{k|k} is zero padded to match dimensions of R_{k+1|k}

Now, all which is needed to get d_{k+1|k+1} is to incorporate the new measurements z_{k+1|k+1} (encoded in b̆_{k+1|k+1}). Following, this can be done via

d_{k+1|k+1}=R_{k+1|k+1}^{-T}(R_{k+1|k}^{aug}^{^{T}}d_{k+1|k}^{aug}+ [symbol] _{k+1|k+1}^{T}b̆_{k+1|k+1}),

where [symbol] _{k+1|k+1}≡ [symbol] _{k+1|k} according to Eq. (34).

### The OTM—Only Observations Method—OTM-OO

The OTM-OO method is a variant of the OTM method. OTM-OO aspires to utilize even more information from the planning stage. Since the motion models from inference and the precursory planning first step are identical, i.e. same function ƒ(.,.), see Eqs. (12) and (21), and as in both cases the same control is considered—to Eq. (26), there is no reason to change the motion model data from the RHS vector d_{k+1|k}. In order to enable the aforementioned, the matching rotation matrix is required. One way would be to break down the planning stage as described above into two stages, in which the motion and observation models are updated separately. Such breakdown impose no effect over the computation time or accuracy of the planning stage solution, as will be shown later on.

Accordingly, the RHS vector is obtained from planning with the motion model ( [symbol] ), augment it with the new measurements and rotate it with the corresponding rotation matrix obtained from the planning stage.

$${d}_{k + 1 \vert k + 1} = {Q}_{k + 1 \vert k}^{{ℋ}^{T}} [ \begin{matrix}{d}_{k + 1 \vert k}^{ℱ} \\ {\breve{b}}_{k + 1 \vert k + 1}^{ℋ}\end{matrix} ] \qquad ( 42 )$$

While the rotation matrix Q_{k+1|k}^{H} is given from the precursory planning stage where

$${Q}_{k + 1 \vert k}^{ℋ} {R}_{k + 1 \vert k}^{ℋ} = [ \begin{matrix}{R}_{k + 1 \vert k}^{ℱ} \\ {ℋ}_{k + 1 \vert k}\end{matrix} ] ; {Q}_{k + 1 \vert k}^{ℱ} {R}_{k + 1 \vert k}^{ℱ} = [ \begin{matrix}{R}_{k \vert k} \\ {ℱ}_{k + 1 \vert k}\end{matrix} ] \qquad ( 43 )$$

As will be seen later on, the OTM-OO method would prove to be the most efficient between the four suggested methods.

### The DU—Only Observations Method—DU-OO

The DU-OO method is a variant of the DU method, where, similarly to Section 0.4.3, we utilize the fact that there is no reason to change the motion model data from the RHS vector d_{k+1|k}. Hence, we would downdate all data with the exception of the motion model, and then update accordingly. As opposed to the DU method, the current downdate will need to be done using

[symbol]

= [symbol] (R_{k+1|k}^{T}d_{k+1|k}− [symbol] ₖ₊₁^{T} [symbol] ), (44)

where [symbol] is the RHS vector, downdated from all new measurements with the exception of the motion model and [symbol] is the equivalent downdated R_{k+1|k} matrix which is given by

[symbol]

=A_{k+1|k}^{T}A_{k+1|k}− [symbol] , (45)

where [symbol] _{k+1|k} denotes the portion of the planning stage Jacobian, of the new factors with the exception of the motion model. Now, all which is left, is to update [symbol] with the new measurements from the inference stage.

d_{k+1|k+1}=R_{k+1|k+1}^{-T}( [symbol] + [symbol] )

### Inconsistent Data Association

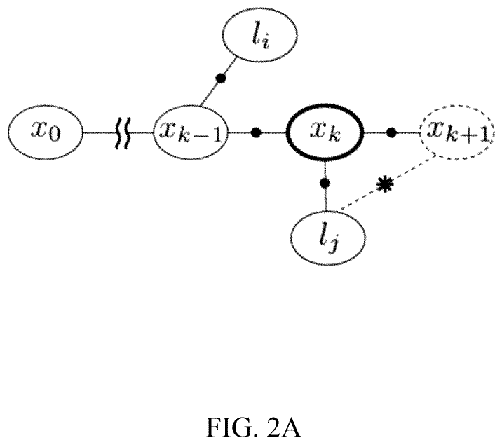

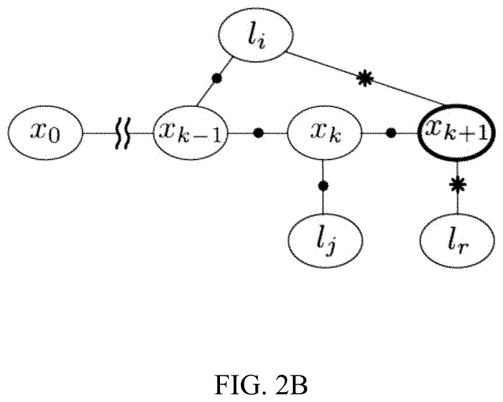

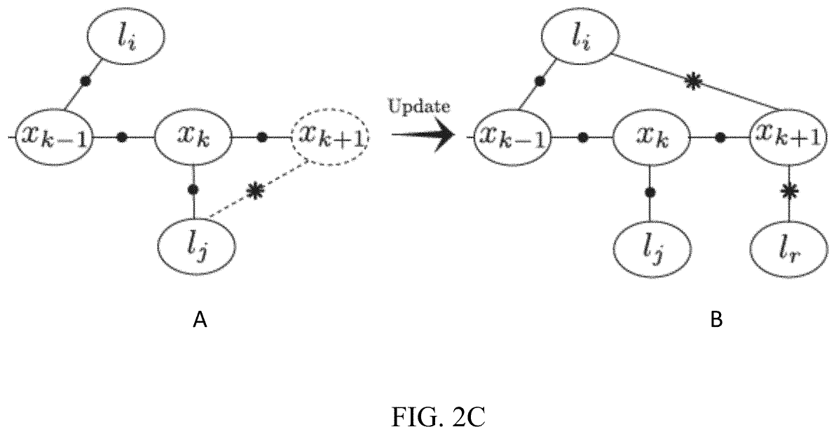

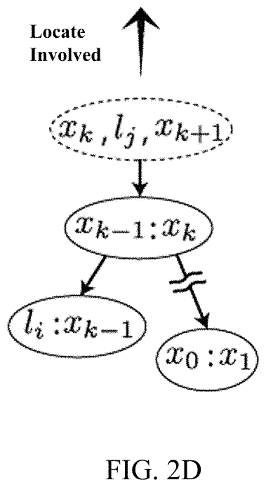

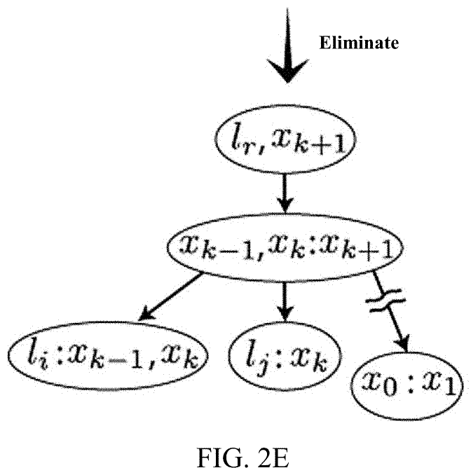

In some embodiments, the simplifying assumption mentioned above is relaxed, to demonstrate that inference can also be efficiently updated using the precursory planning stage even when the DA considered in the two processes is partially different. FIGS. 2A-2E illustrate a case of inconsistent DA, where merely updating the measurement values will not resolve the difference between the factor graphs; instead the DA should be updated to match the acquired data, before updating the measurement values. FIGS. 2A-2B illustrate the factor graphs (FG) for b[X_{k+1|k}] and b[X_{k+1|k+1}], which may differ due to incorrect association considered in the planning phase. The current-time poses Xₖ and Xₖ₊₁ are marked in bold circles, while horizon factors and states are marked in dotted circles. As can be seen, DA variable h was predicted to be observed within planning, while in practice lᵢ and lᵣ were observed at time instance k+1. The belief b[X_{k+1|k}] is represented by a Bayes tree shown in FIG. 2D, which is divided in two: sub Bayes tree containing all involved variables and parent cliques up to the root, and the rest of the Bayes tree. The sub-Bayes tree is re-eliminated by (i) forming the corresponding portion of the factor graph, as shown in the panel A of FIG. 2C; (ii) removing incorrect DA and adding correct DA factors, which yields the factor graph shown in the panel B of FIG. 2C; (iii) re-eliminating that factor graph into a sub-Bayes tree shown in FIG. 2E; and (iv) re-attaching the rest of the Bayes tree. While the obtained Bayes tree now has a correct DA, it is conditioned on (potentially) incorrect measurement values for consistent-DA factors, which therefore need to be updated (as further detailed below), to recover the posterior belief b[X_{k+1|k+1}].

In order to address this more general and realistic scenario, the DA might require correction before proceeding to update the new acquired measurements. The following covers the possible scenarios of inconsistent data association and its graphical materialization, followed by a paradigm to update inconsistent DA from planning stage according to the actual DA attained in the consecutive inference stage. Later the computational aspects and the sensitivity of the paradigm to various parameters are examined, based on simulated and real-life data.

The actual difference between the two aforementioned beliefs b[X_{k+1|k}] and b[X_{k+1|k+1}] will now be addressed. As already presented above, in case of a consistent DA, i.e., [symbol] ₖ₊₁₊ₖ= [symbol] _{k+1|k+1}, the difference between the two beliefs is narrowed down to the RHS vectors d_{k+1|k} and d_{k+1|k+1} which encapsulates the measurements z_{k+1|k} and z_{k+l|k+1} respectively.

However, in the real world, it is possible that the DA predicted in precursory planning would prove to be inconsistent to the DA attained in inference, i.e., ⋄ [symbol] [symbol] _{k+1|k}≠ [symbol] _{k+1|k+1} [symbol] .

There are six possible scenarios representing the relations between DA in inference and precursory planning:
In planning, association is assumed to either a new or existing variable, while in inference no measurement is received.
In planning, it is assumed there will be no measurement to associate to, while in inference a measurement is received and associated to either a new or existing variable.
In planning, association is assumed to an existing variable, while in inference it is to a new variable.
In planning, association is assumed to a new variable, while in inference it is to an existing variable.
In planning, association is assumed to an existing variable, while in inference it is also to an existing variable (whether the same or not).
In planning, association is assumed to a new variable, while in inference it is also to a new variable (whether the same or not).

While the first four scenarios always describe inconsistent DA situations (e.g., in planning it is assumed that a known tree would be visible, but instead a new branch was seen, or vice versa), the last two scenarios may provide consistent DA situations. In case associations in planning and in inference are to the same (un)known variables, we would have a consistent DA.

While different planning paradigms might diminish occurrences of inconsistent DA, e.g., by better predicting future associations, none can avoid it completely. As noted above, the present disclosure does not predict occurrences of new landmarks, hence every new landmark in inference would result in inconsistent DA.

Accordingly, following is a proposed method to update inconsistent DA, regardless of a specific inconsistency scenario or a solution paradigm. This method utilizes the incremental methodologies of iSAM2 in order to efficiently update the belief from the planning stage to be with consistent DA to that of the succeeding inference.

Inconsistent DA can be interpreted as disparate connections between variables. As discussed earlier, these connections, denoted as factors, manifest in rows of the Jacobian matrix or in factor nodes of a FG. Two FGs with different DA would thus have different graph topology. The inconsistent DA impact over graph topology was demonstrated using the example presented in FIGS. 2A-2E. FIG. 2A represents the belief b[X_{k+1|k}] from planning stage, and FIG. 2B represents the belief b[X_{k+1|k+1}] from the inference stage. Even though the same elimination order is used, the inconsistent DA would also create a different topology between the resulting BTs, e.g., the resulting BTs for the aforementioned FGs are FIGS. 2A and 2B accordingly.

Performing action u_{k|k+1}, provides new measurements z_{k+1|k+1}, which are gathered to the factor set {ƒⱼ}_{k+1|k+1}. From the precursory planning stage, we have the belief b[X_{k+1|k}] along with the corresponding factor set {ƒᵢ}_{k+1|k} for time k+1. Since inference was performed over this belief during the planning stage, the FG, denoted as [symbol] _{k+1|k}, was already eliminated into a BT denoted as [symbol] _{1|k}, e.g., see FIGS. 2A and 2D, respectively.

Both the FG [symbol] _{k+1|k} and the BT [symbol] _{k+1|k} could be updated from the planning stage, using the new factors {ƒⱼ}_{k+1|k+1} from the inference stage. Without loosing generality, FIGS. 2A-2E are used to demonstrate and explain the DA update process. Let us consider all factors of time k+1 from both planning {ƒᵢ}_{k+1|k} and inference {ƒⱼ}_{k+1|k+1}. These factors can be divided into three categories:

The first category contains factors with consistent DA—Good Factors. These factors originate from only the last two DA scenarios, in which both planning and inference considered either the same existing variable or a new one. Consistent DA factors do not require attention (other than updating the measurements in the RHS vector). Indices of consistent DA factors can be obtained by intersecting the DA from planning with that of inference:

[symbol]

ₖ₊₁^{∩}= [symbol] _{k+1|k}∩ [symbol] _{k+1|k+1}. (46)

The second category—Wrong Factors, contains factors from planning stage with inconsistent DA to inference, which therefore should be removed from [symbol] _{k+1|k}. These factors can originate from all DA scenarios excluding the second. Indices of inconsistent DA factors from planning, can be obtained by calculating the relative complement of [symbol] _{k+1|k} with respect to [symbol] _{k+1|k+1}:

[symbol]

ₖ₊₁^{rmv}= [symbol] _{k+1|k}\ [symbol] _{k+1|k+1}. (47)

The third category—New Factors, contains factors from the inference stage with inconsistent DA to planning; hence, these factors should be added to [symbol] _{k+1|k}. These factors can originate from all DA scenarios excluding the first. Indices of inconsistent DA factors from inference, can be obtained by calculating the relative complement of [symbol] _{k+1|k+1} with respect to [symbol] _{k+1|k}:

[symbol]

ₖ₊₁^{add}= [symbol] _{k+1|k+1}\ [symbol] _{k+1|k}. (48)

The example from FIGS. 2A-2E can now be used to illustrate these different categories:
The first category—Good Factors, contains all factors from time k+1 that appear both in FIGS. 2A and 2B, i.e., the motion model factor between xₖ to x_{k+1.}
The second category—Wrong Factors, contains all factors that appear only in FIG. 2A, i.e., the star marked factor in FIG. 2A. In this case the inconsistent DA is to an existing variable, landmark lⱼ was considered to be observed in planning but is not seen in the succeeding inference.
The third category—New Factors, contains all factors that appear only in FIG. 2B, i.e., the star marked factors in FIG. 2B. In this case the inconsistent DA is both to an existing and a new variable. Instead of landmark lⱼ that was considered to be observed in planning, a different existing landmark lᵢ has been seen, along with a new landmark lᵣ.

Once the three aforementioned categories are determined, iSAM2 methodologies are used to incrementally update [symbol] _{k+1|k} and [symbol] _{k+1|k}, see Algorithm 1 below. The involved factors are denoted by all factors from planning needed to be removed (Wrong Factors), and all factors from inference needed to be added (New Factors),

{ƒᵣ}ₖ₊₁^{rmv}= [symbol] ƒᵣ,{ƒₛ}ₖ₊₁^{add}= [symbol] ƒₛ. (49)

Algorithm 1: Data Association Update

| 1. | Function: UpdateDA( [symbol] _{k+1\|k} , [symbol] _{k+1\|k} , [symbol] _{k+1\|k+1} , [symbol] _{k+1\|k+1}) | |
|---|---|---|
| 2. | [symbol] ₖ₊₁^{rmv} ← [symbol] _{k+1\|k}\ [symbol] _{k+1\|k+1} | indices of factors required to be removed |

| | | |
|---|---|---|
| 3. | [symbol] ₖ₊₁^{add} ← M_{k+1\|k+1}\ [symbol] _{k+1\|k} | indices of factors required to be added |

| | | |
|---|---|---|
| 4. | {fᵣ}ₖ₊₁^{rmv} ← [symbol] {fᵣ}ₖ₊₁ | factors required to be removed |

| | | |
|---|---|---|
| 5. | {fₛ}ₖ₊₁^{add} ← [symbol] {fₛ}ₖ₊₁ | factors required to be added |

| | | |
|---|---|---|
| 6. | {X}ₖ₊₁^{inv} ← Variables({fᵣ}ₖ₊₁^{rmv}) ∪ Variables({fₛ}ₖ₊₁^{add}) | get involved variables |

| | | |
|---|---|---|
| 7. | [symbol] ₖ₊₁^{inv} ← [symbol] _{k+1\|k}^{{X}}^{ₖ₊₁}^{^{inv}} | get corresponding sub-BT |
| 8. | ${\{ X \}}_{k + 1}^{inv *} {←}^{get all variables} {𝒯}_{k + 1}^{inv}$ | update involved variables |
| 9. | [symbol] ₖ₊₁^{inv} ← [symbol] _{k+1\|k}^{{X}}^{ₖ₊₁}^{^{inv*}} | get corresponding sub-FG |

| | | |
|---|---|---|
| 10. | [symbol] ₖ₊₁^{upd} ← [ [symbol] ₖ₊₁^{inv}\{fᵣ}ₖ₊₁^{rmv}] ∪ {fₛ}ₖ₊₁^{add} | Update the sub Factor Graph |

| | | |
|---|---|---|
| 11. | ${𝒯}_{k + 1}^{upd} {←}^{eliminate} {ℱ𝒢}_{k + 1}^{upd}$ | re-eliminate the updated sub-FG into BT |

| | | |
|---|---|---|
| 12. | [symbol] _{k+1\|k}^{upd} ← [ [symbol] _{k+1\|k}\ [symbol] ₖ₊₁^{inv}] ∪ [symbol] ₖ₊₁^{upd} | Update the Factor Graph |

| | | |
|---|---|---|
| 13. | [symbol] _{k+1\|k}^{upd} ← [ [symbol] _{k+1\|k}\ [symbol] ₖ₊₁^{inv}] ∪ [symbol] ₖ₊₁^{upd} | Update the Bayes Tree |

| | |
|---|---|
| 14. | return [symbol] _{k+1\|k}^{upd}, [symbol] _{k+1\|k}^{upd} |
| 15. | end function |

The involved variables, denoted by {X}ₖ₊₁^{inv}, are all variables related to the factor set {ƒᵣ}ₖ₊₁^{rmv} and the factor set {ƒᵣ}ₖ₊₁^{add} (Alg. 1, line 6), e.g. the colored variables in FIGS. 2A-2B accordingly. In [symbol] _{k+1|k}, all cliques between the ones containing {X}ₖ₊₁^{inv} up to the root are marked and denoted as the involved cliques, e.g., in FIG. 2D. The involved cliques are detached and denoted by [symbol] ₖ₊₁^{inv}⊂ [symbol] _{k+1|k} (Alg. 1, line 7). This sub-BT [symbol] ₖ₊₁^{inv}, contains more variables than just {X}ₖ₊₁^{inv}. The involved variable set {X}ₖ₊₁^{inv}, is then updated to contain all variables from [symbol] ₖ₊₁^{inv} and denoted by {X}ₖ₊₁^{inv}* (Alg. 1, line 8). The art of [symbol] _{k+1|k}, that contains all involved variables {X}ₖ₊₁^{inv}* is detached and denoted by [symbol] ₖ₊₁^{inv} (Alg. 1, line 9). While [symbol] ₖ₊₁^{inv} is the corresponding sub-BT to the acquired sub-FG [symbol] ₖ₊₁^{inv}.

In order to finish updating the DA, all that remains is updating the sub-FG [symbol] ₖ₊₁^{inv} with the correct DA and re-eliminate it to get an updated BT. All factors {ƒᵣ}ₖ₊₁^{rmv} are removed from [symbol] ₖ₊₁^{inv}, then all factors {ƒᵣ}ₖ₊₁^{add} are added (Alg. 1, line 10). The updated sub-FG is denoted by [symbol] ₖ₊₁^{upd}, e.g. update illustration in FIG. 2C.

By re-eliminating [symbol] ₖ₊₁^{upd}, a new updated BT, denoted by [symbol] ₖ₊₁^{upd} is obtained (Alg. 1, line 11), e.g., in FIG. 2E. This BT is then re-attached back to [symbol] _{k+1|k} instead of [symbol] ₖ₊₁^{inv}, subsequently the new BT is now with consistent DA and is denoted as [symbol] _{k+1|k}^{upd} (Alg. 1, line 13). In a similar manner [symbol] _{k+1|k}^{upd} is obtained by re-attaching [symbol] ₖ₊₁^{upd} instead of [symbol] ₖ₊₁^{inv} to [symbol] _{k+1|k} (Alg. 1, line 12). At this point the DA in both the FG and the BT is fixed. For example, by completing the aforementioned steps, FIGS. 2A, 2D will have the same topology as FIGS. 2B, 2E.

After the DA update, the BT [symbol] _{k+1|k}^{upd} has consistent DA to that of [symbol] _{k+1|k+1}. However, it is still not identical to [symbol] _{k+1|k+1} due to difference between measurement values predicted in planning to the values obtained in inference. The DA update dealt with inconsistent DA factors and their counterparts. For these factors the new measurements from inference were updated in the corresponding RHS vector values within the BT. The consistent DA factors, on the other hand, were left untouched; therefore, these factors do not contain the new measurement values from inference but measurement values from the planning stage instead. These inconsistent measurements are thus baked into the RHS vector d_{k+1|k} and in the appropriate cliques of the BT [symbol] _{k+1|k}^{upd}. In order to update the RHS vector d_{k+1|k}, or equivalently update the corresponding values within relevant cliques of the BT, one can use any of the methods presented above.

### Experimental Results

In this section, the present disclosure is benchmarked against the standard Bayesian inference approach using iSAM2 efficient methodologies as a proving-ground.

The problem of autonomous navigation and mapping in an unknown environment, e.g., by a robot, is considered as a testbed for the present disclosure, first in a simulated environment and later-on in a real-world environment. The robot performs inference to maintain a belief over its current and past poses and the observed landmarks thus far (i.e., full-SLAM), and uses this belief to decide its next actions within the framework of belief space planning. As mentioned earlier, the present disclosure is indifferent to a specific method of inference or decision making.

In order to test the computational effort, inference update was compared using iSAM2 efficient methodology, once based on the standard Bayesian inference paradigm (denoted herein as iSAM), against the present disclosure inference paradigm.

All of the complementary methods required to enable inference update based on the present disclosure, were implemented in MATLAB and are encased within the inference block. The iSAM approach uses the GTSAM C++ implementation with the supplied MATLAB wrapper. Considering the general rule of thumb, that MATLAB implementation is at least one order of magnitude slower, the comparison to iSAM as a reference is extremely conservative. All runs were executed on the same Linux-based computing system, with Xeon E3-1241v3 3.5 GHz processor with 32 GB of memory.

In order to get better understanding of the difference between the present disclosure and the standard Bayesian inference, we refer to the high-level algorithm diagram given in FIGS. 1A-1B, which depict a plan-act-infer framework. FIG. 1A represents a standard Bayesian inference, where only the first inference update iteration is timed for comparison reasons. FIG. 1B shows the present disclosure, while the DA update, along with the first inference update iteration, are being timed for comparison. The computation time comparison is made only over the inference stage, since the rest of the plan-act-infer framework is identical in both cases.

As mentioned, the present disclosure does not affect estimation accuracy. This was verified in the following experiments, by comparing the estimation results obtained using the present approach and iSAM. Both provide essentially the same results in all cases

### Basic Analysis

The purpose of this experiment is to provide with a basic comparison between the present disclosure and the existing standard Bayesian inference.

This simulation preforms a single horizon BSP calculation, followed by an inference step with a single inference update. The simulation provides a basic analysis of running time for each method, denoted by the z axis, for a fully dense information matrix and with no loop closures. The presented running time is a result of an average between 10³ repetitions per step per method. Although a fully dense matrix does not represent a real-world scenario, it provides a sufficient initial comparison. The simulation analyzes the sensitivity of each method to the initial state vector size, denoted by they axis, and to the number of new factors, denoted by x axis. Since we perform a single horizon step with a single inference update, no re-linearization is necessary; hence, iSAM comparison is valid. The purpose of this check is to provide a simple sensitivity analysis of the present methods to state dimension and number of new factors per step, while compared against standard batch update (denoted as STD) and iSAM paradigm. While both STD and iSAM are based on the standard Bayesian inference paradigm, the rest of the methods are based on the novel the present disclosure.

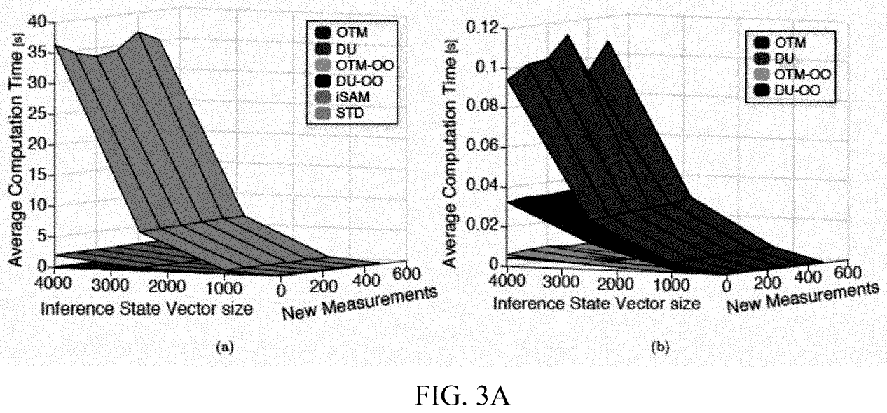

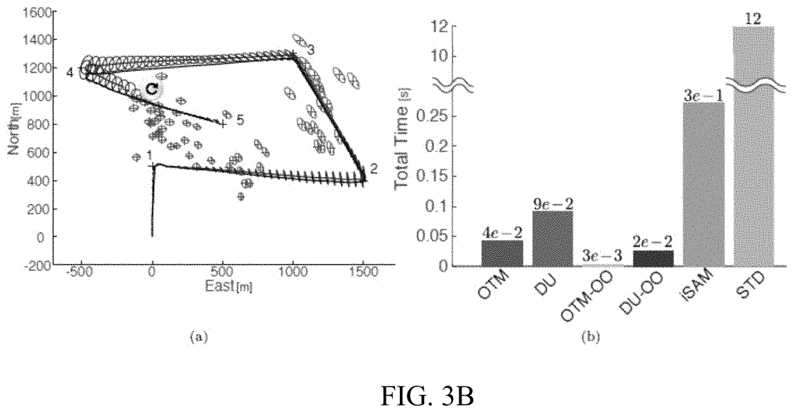

FIG. 3A (panel (a)) presents average timing results for all methods. After inspecting the results, it was found that for all methods, running time is a nonlinear, positive gradient function of the inference state vector size and a linear function of the number of new measurements. While the running time dependency over the number of new measurements grows with the inference state vector size. For all inspected parameters, the present methods score the lowest running time with a difference of up to three orders ofmagnitude comparing to iSAM. FIG. 3A (panel (b)) presents running time of the present methods. Interestingly, the OTM methodology proves to be more time efficient than the DU methodology, while for both the OO addition improves running time, thus scoring all methods from the fastest to the slowest with a time difference of four orders of magnitude between the opposites:
OTM-OO⇒OTM⇒DU-OO⇒DU⇒iSAM⇒STD

### BSP in Unknown Environment—Consistent DA

The purpose of this experiment is to further examine the present disclosure, in a real world scenario, under the simplifying assumption of consistent DA. The second simulation preforms BSP over continuous action space, in an unknown synthetic environment. Since now the synthetic environment replicates a real world scenario, the obtained information matrix is of course sparse. A robot was given five targets (see FIG. 3B, panel (a)) while all landmarks were a-priori unknown, and was required to visit all targets whilst not crossing a covariance value threshold. The largest loop closure in the trajectory of the robot, and the first in a series of large loop closures, is denoted by a ‘loop’ sign across all relevant graphs. The robot preforms BSP over continuous action space, with a finite horizon of five look ahead steps. During the inference update stage each of the aforementioned methods were timed performing the first inference update step. It is worth mentioning that the present disclosure is impervious to a specific planning method or whether the action space is discrete or continuous.

The presented running time is a result of an average between 103 repetitions per step per method. Similarly to above, as can be seen in FIG. 3B, panel (B), the suggested MATLAB implemented methods are up to two orders of magnitude faster than iSAM used in a MATLAB C++ wrapper. Interestingly, the use of sparse information matrices changed the methods timing hierarchy. While OTM-OO still has the best timing results (3×10⁻³ sec), two orders of magnitude faster than iSAM, OTM and DU-OO switched places. So the timing hierarchy from fastest to slowest is: OTM-OO⇒DU-OO⇒OTM⇒DU⇒iSAM⇒STD

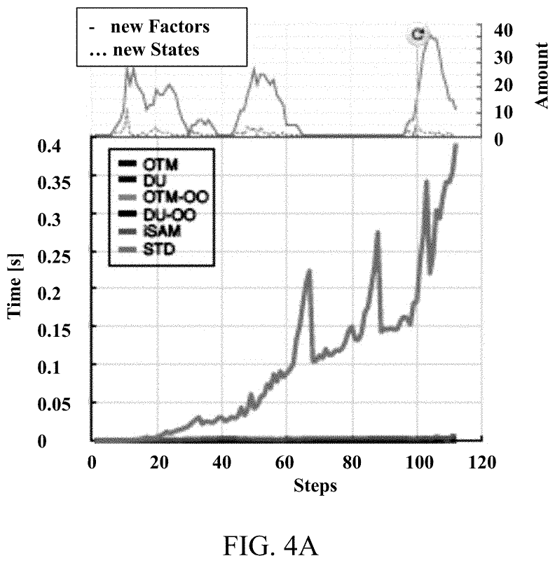

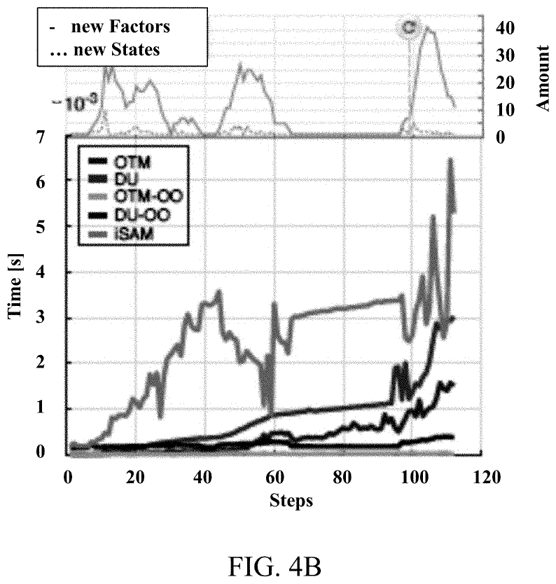

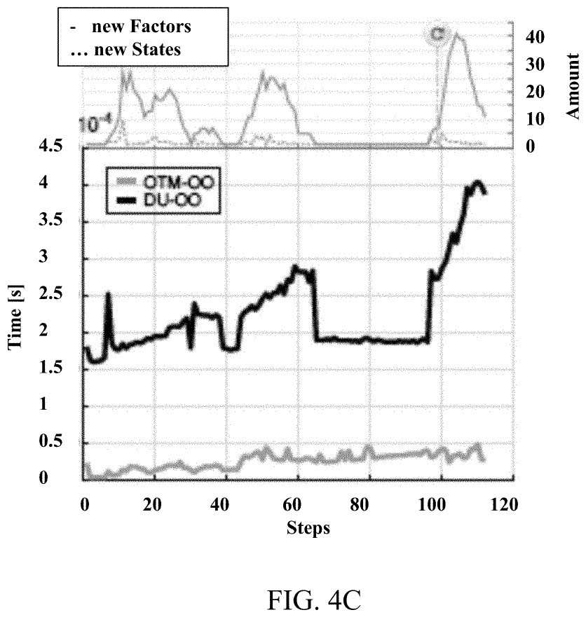

After demonstrating the use of the present disclosure drastically reduce cumulative running time, we continue on to showing that in few aspects it is also less sensitive. FIGS. 4A-4C present the performance results of each of the methods per simulation step. The upper graphs present the number of new factors and new states per each step, while the lower graph presents the average running time of each method as a function of the simulation step. The ‘loop’ sign represents the first largest loop closure in a series of large loop closures. While some of the behavior presented in FIGS. 4A-4C can be related to machine noise, from carefully inspecting the results several interesting observations can still be made. The first observations relate to the “flat line” area noticeable in the upper graph of FIG. 4B between time steps 60-90. This time steps range is equivalent to the path between the 3^{rd} and 4ₜₕ targets, were the only factor added to the belief is motion based. As a result, a single new state (the new pose) is presented to the belief, along with a single motion factor. In this range, the timing results of iSAM DU and OTM present a linear behavior with a relatively small gradient. This gradient is attributed to the computational effort of introducing a single factor, containing a new state, to the belief. While the vertical difference between the aforementioned can be attributed to the sensitivity of each method to the number of states and factors in the belief.

From this observation, we can better understand the reason for the substantial time difference between the methods. Basing a method on the present disclosure, rather than on standard Bayesian inference, will not change the computational impact of introducing factors or new states to the belief. However, it would reduce the sensitivity of the method to the sizes of the state vector and the belief (attributed to number of factors).

Another interesting observation refers to “pure” loop closures, were there are measurements with no addition of new variables to the state vector, i.e., measurements to previously observed landmarks. For the case of “pure” loop closures, STD, iSAM and the DU based methods (i.e. DU and DU-OO) experienced the largest timing spikes throughout the trajectory while both OTM based methods experienced minor spikes if any.

While both DU and OTM present some sensitivity to different occurrences, i.e. the size of the state vector, new measurements and loop closures, this sensitivity is drastically reduced by introducing the OO methodology, e.g. the once positive gradient line in DU during time steps 60-90, turned into a flat line in DU-OO as can easily be seen in FIG. 4C.

In conclusion, the present methods, particularly OTM-OO, seem to be impervious to large loop closures, state vector size, belief size, number of newly added measurements or even the combination of the aforementioned.

### BSP in Unknown Environment—Relaxing Consistent DA Assumption

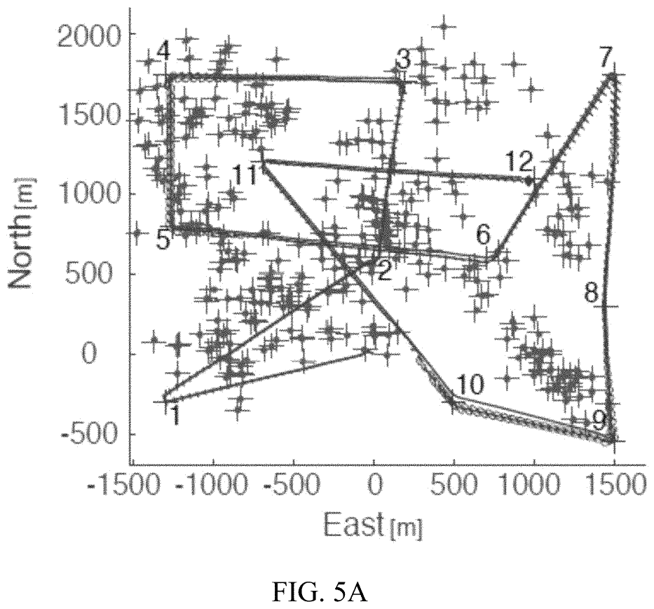

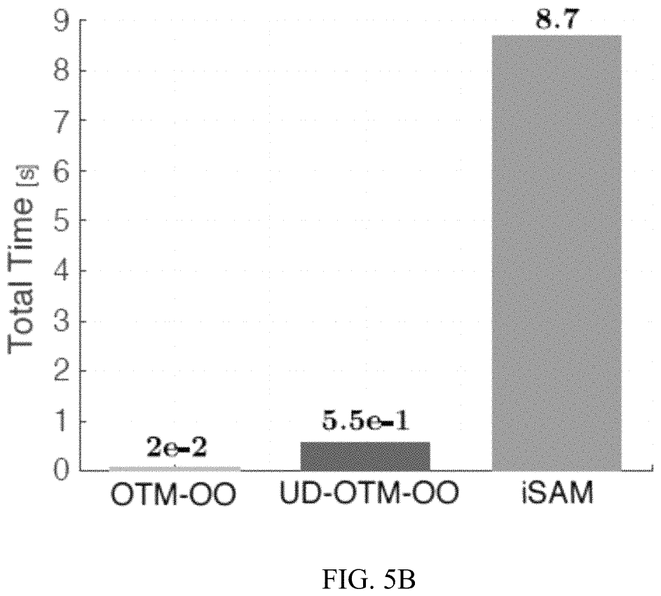

The purpose of this experiment is to further examine the present disclosure, in a real world scenario, while relaxing the simplifying assumption of consistent DA. The third simulation preforms BSP over continuous action space, in an unknown synthetic environment. A robot was given twelve targets (see FIG. 5A) while all landmarks were a-priori unknown, and was required to visit all targets whilst not crossing a covariance value threshold.

The experiments were based on the simplifying assumption of consistent DA between inference and precursory planning, which can often be violated in real world scenarios. In this simulation we relax this restricting assumption and test the present disclosure under the more general case were DA might be inconsistent.

The main reason for inconsistent data association lies in the perturbations caused by imperfect system and environment models. These perturbations increase the likelihood of inconsistent DA between inference and precursory planning. While the planning paradigm uses the state estimation to decide on future associations, the further it is from the ground truth the more likely for inconsistent DA to be received. This imperfection is modeled by formulating uncertainty in all models.

For a more conservative comparison, in addition to the aforementioned, we use a mechanism that would increase the inconsistency of the DA between inference and precursory planning. In contrast to planning paradigms that can provide DA to new variables, in addition to an unknown map, the robot's planning paradigm considers only previously-mapped landmarks. As a result of this limitation, the DA received from the planning stage cannot offer new landmarks to the state vector. Consequently, each new landmark would essentially mean facing inconsistent DA, while the single scenario in which a consistent DA is obtained, occurs when both planning and inference are considering the same known landmark. Both perturbations caused by uncertainty and considering only previously mapped landmarks, resulted in just 50% DA consistency between planning and succeeding inference in this experiment.

Following the findings above, out of the four suggested methods we choose to continue the comparison just with the OTM-OO method. While OTM-OO assumed consistent DA, the more general approach deals with inconsistent DA before updating the RHS vector. We denote the complete approach, updating DA followed by OTM-OO, as UD-OTM-OO, where UD stands for Update Data association. It is important to clarify that UD-OTM-OO and for consistent DA also OTM-OO, yield the same estimation accuracy as iSAM, since the inference update using inference results from the present disclosure in the same topological graph with the same values. For that reason, the accuracy aspect will not be discussed further in this section. FIG. 5B presents the cumulative computation time of the inference update phase throughout the simulation. Although UD-OTM-OO total running time is larger than OTM-OO due to the need for DA update (as to be expected), it still outperforms iSAM by an order of magnitude.

In addition to the improvement in total computation time of the inference update stage, we continue on analyzing the “per step” behavior of UD-OTM-OO, and demonstrate that in few aspects it is less sensitive than iSAM.

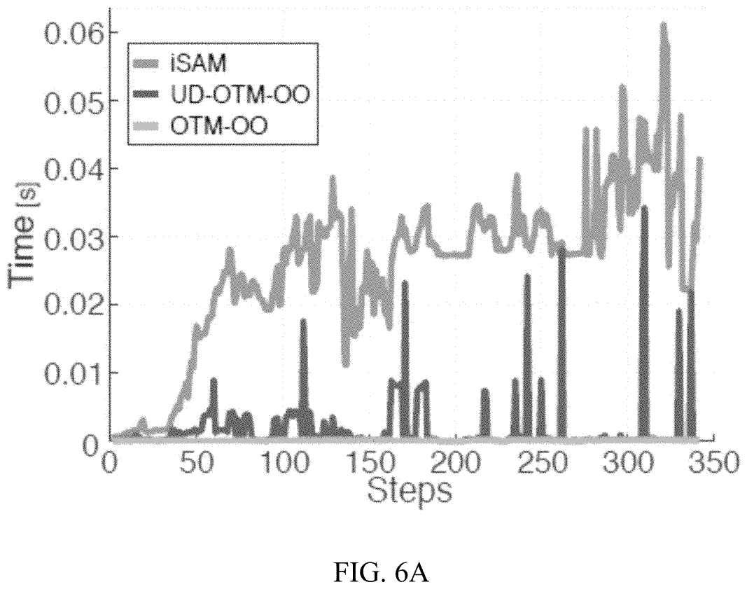

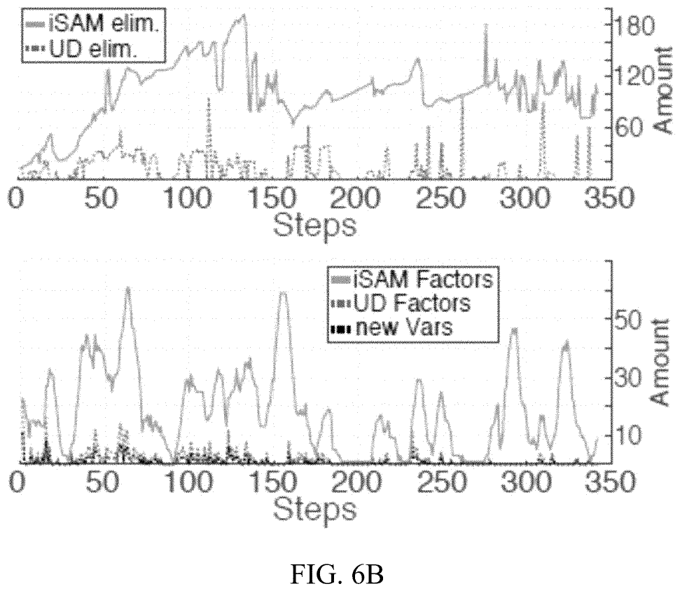

FIG. 6A illustrates the per-step analysis of the simulation presented in FIGS. 5A-5B. The present disclosure not only outperforms iSAM in the cumulative computation time, but also outperforms it for each individual step. While FIG. 6A presents the difference in average computation time per-step, FIG. 6B captures the reason for this difference as suggested above. FIG. 6B (lower graph) presents the number of factors and new variables added in iSAM as opposed to UD-OTM-OO. FIG. 6B (upper graph) presents the number of eliminations made during inference update in both methods. Number of eliminations reflects the number of involved variables in the process of converting FG into a BT.

After carefully inspecting both Figures, alongside the robot's trajectory in FIG. 5A, the following observations can be made. Even with the limitation over the planning paradigm, both the number of new factors added and the number of re-eliminations during the inference update stage, are substantially smaller than their iSAM counterparts. These large differences are some of the reasons for UD-OTM-OO better performance. Due to the limitation over the planning paradigm, new observation factors (i.e. new landmarks added each step) in both iSAM and UD-OTM-OO are identical while the latter pose more than half of total factors in the latter. After comparing the re-elimination graph with the timing results, it appears both trends and peaks align, so it is assumed that the present method is mostly sensitive to the amount of re-eliminations. Both re-elimination amount and amount of added factors can be further reduced by reordering and relaxing the limitation over the planning paradigm accordingly. For cases of consistent or partially consistent DA, when encountering a loop closure (i.e. observing a previously mapped landmark) the present method saves valuable computation time since they are only calculated once, in the planning stage (e.g., see timing response for LC at steps 136-159 and 275-308 in FIG. 6A). The present method also seems to be much less sensitive to state dimensionality. Inspecting steps 192-208 and 263-275 in FIG. 6B (lower graph) we observe there are no new factors, i.e., the computation time is a result of motion factors; inspecting FIG. 6A we observe that in spite of the aforementioned, iSAM computation time is much larger than our method. From this comparison we can infer our suggested method is less sensitive to state dimensionality.

### Real-World Experiment Using KITTI Dataset

After the successful experimental results in a simulated environment, the present disclosure was tested for inference update via BSP in a real-world environment using KITTI dataset (see, Geiger, P. Lenz, C. Stiller, and R. Urtasun, “Vision meets robotics: The kitti dataset”, International Journal of Robotics Research (IJRR), 2013).

The KITTI dataset, recorded in the city of Karlsruhe, contains stereo images, Laser scans and GPS data. For this work, the raw images of the left stereo camera were used, from the Residential category file: 2011_10_03_drive_0027, as measurements, as well as the supplied ground truth for comparison.

In this experiment we consider a robot, equipped with a single monocular camera, performing Active Full-SLAM in the previously unknown streets of Karlsruhe Germany. The robot starts with a prior over its initial pose and with no prior over the environment. At time k the robot executes BSP on the single step action sequence taken in the KITTI dataset at time k+1. At the end of each BSP session, the robot executes the chosen action, and receives measurements from the KITTI dataset. Inference update is then being performed in two separate approaches, the first following the standard Bayesian inference approach and the second following the present disclosure inference approach. The inference update following each of which is compared for computation time and accuracy.

The following sections explain in-detail how planning and perception are being executed in this experiment.

### Planning Using KITTI Dataset

Our proposed approach for inference, leverages calculations made in the precursory planning phase to update inference more efficiently. KITTI is a pre-recorded dataset with a single action sequence, i.e. the “future” actions of the robot are pre-determined. Nevertheless, we can still evaluate our approach by appropriately simulating the calculations that would be performed within BSP for that specific (and chosen) single action sequence. In other words, BSP involves belief propagation and objective function evaluations for different candidate actions, followed by identifying the best action via Eq. (11) and its execution.

In our case, the performed actions over time are readily available; hence, we only focus on the corresponding future beliefs for such actions given the partial information available to the robot at planning time. Specifically, at each time instant k, we construct the future belief b[X_{k+1|k}] via Eq. (9) using the supplied visual odometry as motion model and future landmark observations. Future landmark observations are generated by considering only landmarks projected within the camera field of view using MAP estimates for landmark positions and camera pose from the propagated belief b[X_{k+1|k}]. As in this work the planning phase considers only the already-mapped landmarks, without reasoning about expected new landmarks, each new landmark observation in inference would essentially mean facing inconsistent DA.

### Perception Using KITTI Dataset

After executing the next (sub)optimal action, the robot receives a corresponding raw image from the KITTI dataset. The image is being processed through a standard vision pipeline, which produces features with corresponding descriptors. Landmark triangulation is being made after the same feature has been observed at least twice, while following different conditions designed to filter outliers. Once a feature is triangulated, it is considered as a landmark, and is added as a new state to the belief. Note that the robot has access only to its current joint belief, consisting of the estimated landmark locations, and the robot past and present pose estimations. Once the observation factors in Eq. (6) are added to the belief, the inference update is being made in two different and separate ways. The first, used for comparison, follows the standard Bayesian inference, by using the efficient methodologies of iSAM2 in order to update inference. The belief of the preceding inference b[X_{k|k}] is being updated with the new motion and observation factors {ƒⱼ}_{k+1|k+1}, thus obtaining b[X_{k+1|k+1}].

The second method follows the present disclosure. The belief from the preceding planning phase, b[X_{k+1|k}], which corresponds to u_{k|k+1}, is updated with the new measurements. This update is done using UD-OTM-OO which consists of two stages, first using our DA update method which updates the predicted DA to the actual DA, followed by the OTM-OO method which updates measurement values.

### Results—KITTI Dataset

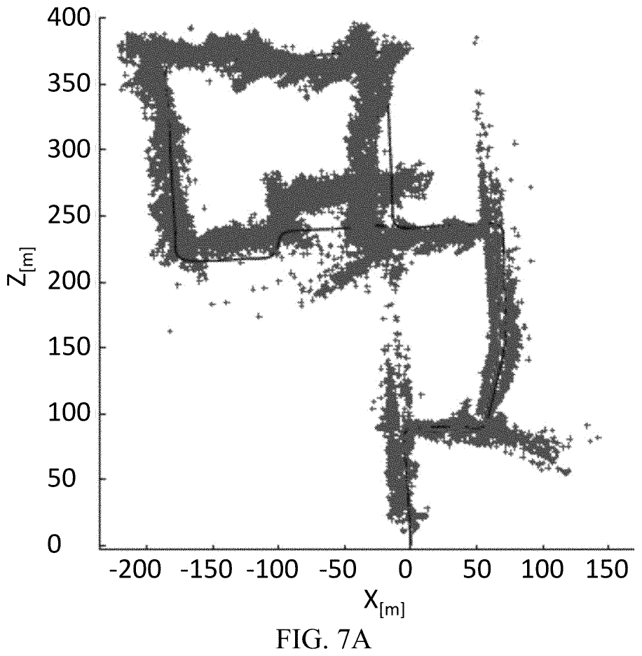

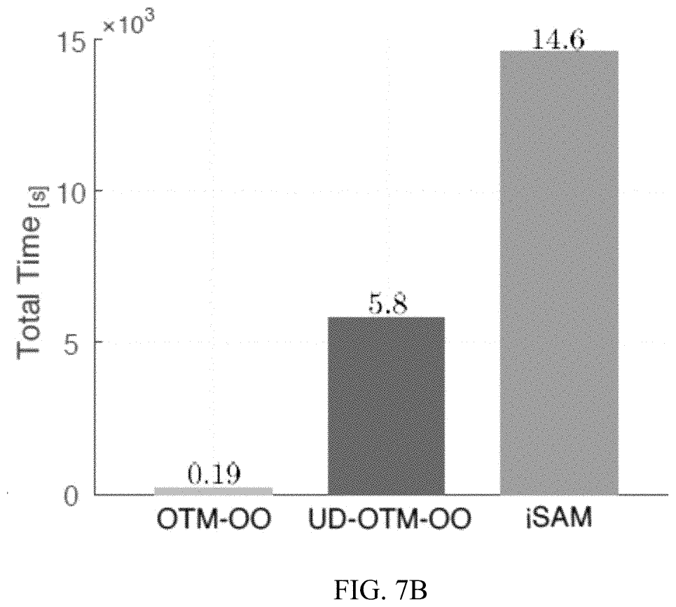

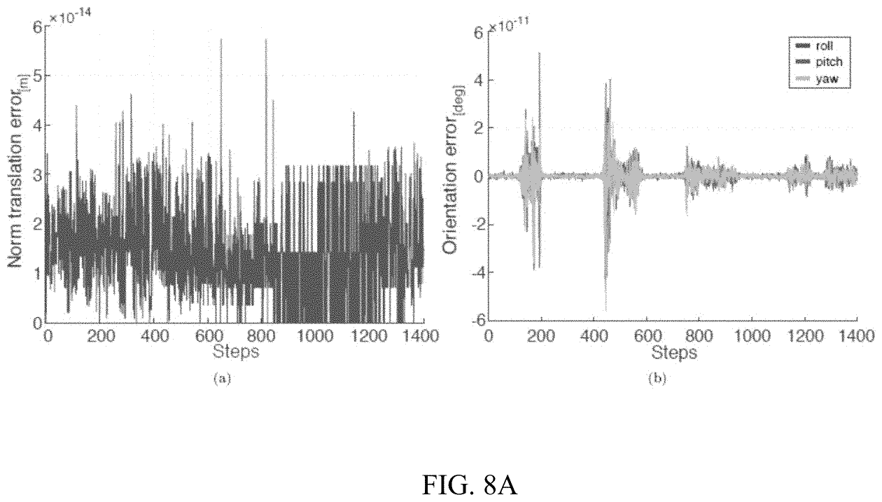

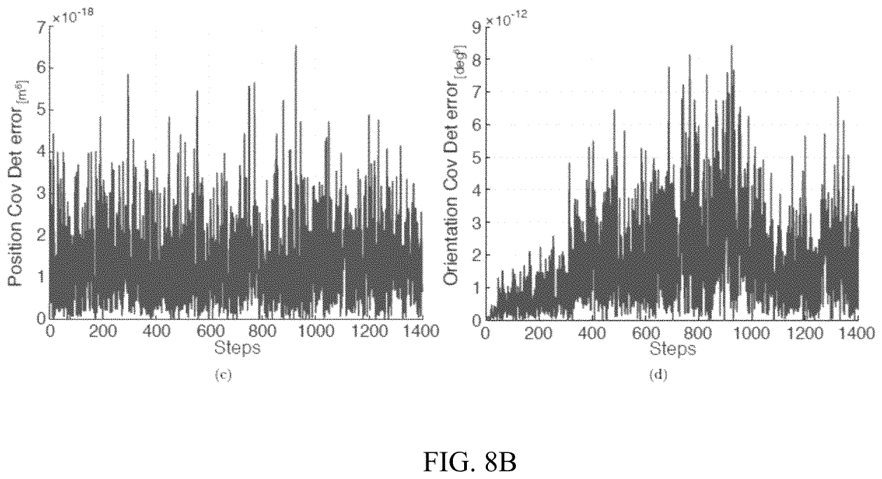

The robot travels 1400 steps in the unknown streets of Karlsruhe Germany, while relying only on a monocular camera for localization and mapping and without encountering any substantial loop closures. FIG. 7A presents the ground truth of the robot's trajectory in blue, the estimated robot's trajectory in dotted red and the estimated location of observed landmarks in green. Both iSAM and UD-OTM-OO produce the same estimation; therefor, the dotted red-line as well as the green marks represents both iSAM and UD-OTM-OO estimations.

FIG. 7B presents the total computation time of inference update throughout the experiment, for iSAM, OTM-OO and UD-OTM-OO. The importance of real-world data can be easily noticed by comparing FIGS. 7B and 5B. While OTM-OO secured its advantage of two orders of magnitude over iSAM, it is not the case with UD-OTM-OO. Although for real-world data, UD-OTM-OO is still faster than iSAM, the difference has decreased from order of magnitude in FIG. 5B, to less than half the computation time in FIG. 7B. Since the same machine has been used in both cases, the difference must originate from the data itself. As will be seen later, the number of measurements per step is substantially higher when using the real-world data, as well as the occurrences of inconsistent DA. It is worth stressing that iSAM implementation for inference update is C++ based, while UD-OTM-OO implementation consists of a mixture of MATLAB based and C++ based implementation, so for the same platform the computation time difference is expected to be higher.

We continue by discussing the estimation difference, between iSAM and our method UD-OTM-OO. Although our method is algebraically equivalent to estimation via iSAM, for the reader's assurance we also provide estimation error comparison for both mean and covariance. In-spite the algebraic equivalence, we expect to obtain small error values, related to numerical noise, which are different from absolute zero.

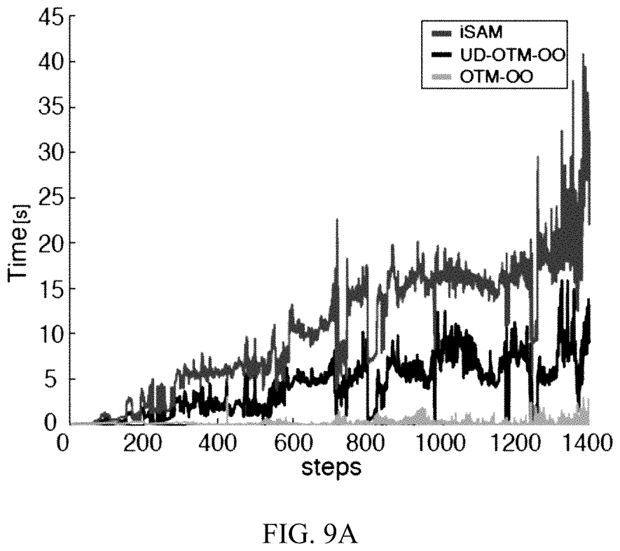

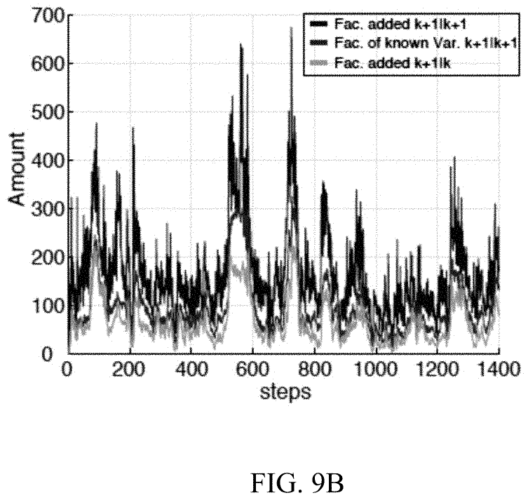

The estimation comparison results are presented in FIGS. 9A-9D: the translation mean in FIG. 9A, the mean rotation of the robot in FIG. 9B, and the corresponding covariances in FIGS. 9C and 9D. The mean translation error is calculated by taking the norm of the difference between the two mean translation vectors. The mean rotation error is calculated by taking the norm of the difference between each of the mean body angles. The covariance error is calculated by taking the norma of the difference between the covariance determinants. As can be seen in FIGS. 9A-9D, the error has a noise like behavior, with values of 10⁻¹⁴ for translation mean, 10⁻¹¹ for mean rotation angles, 10⁻¹⁸ for translation covariance and 10⁻¹² for rotation angles covariance. For all practical purposes, these values points to a negligible accuracy difference between the two methods.

FIG. 9A presents the per-step computation time for inference update of OTM-OO, UD-OTM-OO and iSAM. OTM-OO represents the per-step computation time of inference update through the present disclosure inference for consistent DA, i.e., computation time for updating the RHS with the correct measurement values. UD-OTM-OO represents the per-step computation time of inference update through the present disclosure inference without the assumption of consistent DA. The difference in computational effort between the two, as seen in FIG. 9A, originates from the need to deal with inconsistent DA between belief from planning b[X_{k+1|k}] and succeeding inference b[X_{k+1|k+1}]. The difference in computational effort between UD-OTM-OO and iSAM is attributed to the re-use of calculations made during the precursory planning. This calculation re-use manifests in salvaging factors that have already been considered during the precursory planning.

The reason for the considerable computational time differences between UD-OTM-OO and iSAM is better understood when comparing the factors involved in the computations of each method.

FIG. 9B presents the sum of added factors per-step. In blue, the sum of all factors added at time k+1|k+1, as part of standard Bayesian inference update. In red, the sum of factors added at time k+1|k+1 involving states which are already part of the belief b[X_{k|k}]. In yellow, the amount of factors added in time k+1 and are shared by both beliefs, b[X_{k+1|k}] and b[X_{k+1|k+1}].

The difference between the yellow and blue lines represents the amount of factors “missing” from the belief b[X_{k+1|k}] in order to match b[X_{k+1|k+1}]. This difference can be divided into factors containing only existing states and factors containing new states. Since the red line represents all factors of existing states, the difference between the red and blue lines represents all factors containing new states per time step. As mentioned earlier, in this experiment the prediction of future factors does not involve new states, apart from the next future pose(s). For that reason, the amount of factors added during planning has an upper bound represented by the red line. Future work can consider a prediction mechanism for new states, such work would set the upper bound somewhere between the red and blue lines.

The difference between the yellow and red lines, both related to factors of existing states, is attributed to the prediction accuracy of the planning stage. Since the factors represented by the red line are already part of the belief in planning time k, a perfect prediction mechanism would have added them all to the belief b[X_{k+1|k}]. Since the prediction is inherently imperfect, there would always be some difference between the two. Reducing the gap between the red and yellow lines is a function of the prediction mechanism, while closing the gap further up to the blue line is a function of predicting new variables during planning.

After better understanding the meaning of FIG. 9B, comparing the two graphs in FIGS. 9A-9B reveals the connection between the added factors and the computation time. As anticipated, the larger the gap between b[X_{k+|k}] and b[X_{k+1|k+1}], the smaller the difference between the present disclosure inference and standard Bayesian inference.

In contrast to previous experiments over synthetic data, we can better see here some dependency over the size of the belief in the UD-OTM-OO method. This dependency seems to be in correlation with that of iSAM2 although less intense, as can be seen by comparing the two methods in FIG. 9A. Since UD-OTM-OO makes use of iSAM2 methodologies in order to update inconsistent DA, as does iSAM2 to update inference, they share similar computational sensitivities, which manifest in similar computation time trends. This similarity sensitivity is attributed in our opinion to the elimination process required in order to introduce new factors into the belief. Future work for reducing eliminations by anticipating required ordering, would break this dependency and provide additional improvement in computation time as well as in reducing the sensitivity to state dimensionality.

### APPENDIX—INFERENCE AS A GRAPHICAL MODEL

The inference problem can be naturally represented and efficiently solved using graphical models such as factor graph (FG) and Bayes tree (BT). Since FG and BT graphical models pose key components in the suggested paradigm, the theoretical foundation is supplied next. We use FIGS. 2A-2E as illustration to belief representation in graphical models. FIGS. 2A and 2B are FG representations for the beliefs b(X_{k+1|k}) and b(X_{k+1|k+1}), respectively. BT representation of the belief is obtained through an elimination process, FIG. 2D presents the BT of b[X_{k+1|k}] for the elimination order x₀ . . . lᵢ→xₖ₋₁→xₖ→lⱼ→xₖ₊₁, while FIG. 2E presents the BT of b[X_{k+1|k+1}] for the elimination order x₀ . . . lᵢ→xₖ₋₁→xₖ→lⱼ→lᵣ→xₖ₊₁.

A FG is a bipartite graph with two node types, factor nodes {ƒᵢ} and variable nodes {θⱼ}∈Θ. All nodes are connected through edges {eᵢⱼ}, which are always between factor nodes to variable nodes. A factor graph defines the factorization of a certain function g(Θ) as

g(Θ)=Πᵢƒᵢ(Θᵢ), (50)

where Θᵢ is the set of variables {θⱼ} connected to the factor fi through the set of edges {eᵢⱼ}. After substituting Θ with our joint state X and the factors {ƒᵢ} with the conditional probabilities from Eq. (3) we receive the definition of the belief b(X_{t|k}) in a FG representation.

Through bipartite elimination game, a FG can be converted into a BN, this elimination is required for solving the Inference problem. After eliminating all variables the BN pdf can be defined by a product of conditional probabilities,

P(Θ)=ΠⱼP(ηⱼ|Sⱼ), (51)

where Sⱼ is addressed as the separator of Θⱼ, i.e. the set of variables that are directly connected to Θⱼ. In order to ease optimization and marginalization, a BT can be used. By converting the BN to a directed tree, where the nodes represent cliques {Cᵣ}, we receive a directed graphical model that encodes a factored pdf Bayes Tree is defined using a conditional density per each node.

P(Θ)=ΠᵣP(Fᵣ|Sᵣ), (52)

where Sᵣ is the separator, defined by the intersection Cᵣ∩Πᵣ, of the clique C, and the parent clique Πᵣ. The complement to the variables in the clique Cᵣ is denoted as Fᵣ, the frontal variables. Each clique is therefor written in the form Cᵣ=Fᵣ:Sᵣ.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An autonomous system comprising:
at least one hardware processor;
a sensors module; and
a non-transitory computer-readable storage medium having stored thereon program instructions, the program instructions executable by the at least one hardware processor to:
receive, from said sensors module, a set of measurements associated with a joint state of said autonomous system,
infer, based, at least in part, on said set of measurements, a current belief regarding said joint state of said autonomous system,
determine a control action based on said inference, wherein said determining comprises calculating a future belief regarding a future joint state of said autonomous system, wherein said future joint state is as a result of said control action,
execute said control action, and
generate a new inference based, at least in part, on said future belief, wherein said future belief is updated based on a new set of measurements from said sensors module.

2. The autonomous system of claim 1, wherein said control action implements a specified task of said autonomous system.

3. The autonomous system of claim 1, wherein said joint state of said autonomous system comprises at least some of (i) a current pose of said autonomous system, (ii) past poses of said autonomous system, and (iii) observed landmarks in an environment of said autonomous system.

4. The autonomous system of claim 1, wherein said current belief represents a probability of said joint state.

5. The autonomous system of claim 1, wherein said control action changes said joint state of said autonomous system.

6. The autonomous system of claim 1, wherein said determining comprises determining a sequence of control actions.

7. The autonomous system of claim 1, wherein said future belief is calculated based on at least some of (i) simulating an application of said first control action to said current belief, and (ii) predicting a future set of said measurements.

8. The autonomous system of claim 1, wherein said updating of said future belief comprises correcting data associations of at least one variable and one measurement between (i) said future belief, and (ii) said new set of said measurements from said sensors module, when said data associations are inconsistent.

9. A method comprising:
using at least one hardware processor for:
receiving, from a sensors module, a set of measurements associated with a joint state of an autonomous system,
inferring, based, at least in part, on said set of measurements, a current belief regarding said joint state of said autonomous system,
determining a control action based on said inference, wherein said determining comprises calculating a future belief regarding a future joint state of said autonomous system, wherein said future joint state is as a result of said control action,
executing said control action, and
generating a new inference based, at least in part, on said future belief, wherein said future belief is updated based on a new set of measurements from said sensors module.

10. The method of claim 9, wherein said control action implements a specified task of said autonomous system.

11. The method of claim 9, wherein said joint state of said autonomous system comprises at least some of (i) a current pose of said autonomous system, (ii) past poses of said autonomous system, and (iii) observed landmarks in an environment of said autonomous system.

12. The method of claim 9, wherein said current belief represents a probability of said joint state.

13. The method of claim 9, wherein said control action changes said joint state of said autonomous system.

14. The method of claim 9, wherein said determining comprises determining a sequence of control actions.

15. The method of claim 9, wherein said future belief is calculated based on at least some of (i) simulating an application of said first control action to said current belief, and (ii) predicting a future set of said measurements.

16. The method of claim 9, wherein said updating of said future belief comprises correcting data associations of at least one variable and one measurement between (i) said future belief, and (ii) said new set of said measurements from said sensors module, when said data associations are inconsistent.

17. A computer program product comprising a non-transitory computer-readable storage medium having program instructions embodied therewith, the program instructions executable by at least one hardware processor to:
receive, from a sensors module, a set of measurements associated with a joint state of an autonomous system,
infer, based, at least in part, on said set of measurements, a current belief regarding said joint state of said autonomous system,
determine a control action based on said inference, wherein said determining comprises calculating a future belief regarding a future joint state of said autonomous system, wherein said future joint state is as a result of said control action, execute said control action, and
generate a new inference based, at least in part, on said future belief, wherein said future belief is updated based on a new set of measurements from said sensors module.

18. (canceled)

19. The computer program product of claim 17, wherein said joint state of said autonomous system comprises at least some of (i) a current pose of said autonomous system, (ii) past poses of said autonomous system, and (iii) observed landmarks in an environment of said autonomous system.

20. (canceled)

21. (canceled)

22. (canceled)

23. The computer program product of claim 17, wherein said future belief is calculated based on at least some of (i) simulating an application of said first control action to said current belief, and (ii) predicting a future set of said measurements.

24. The computer program product of claim 17, wherein said updating of said future belief comprises correcting data associations of at least one variable and one measurement between (i) said future belief, and (ii) said new set of said measurements from said sensors module, when said data associations are inconsistent.
